(19) United States
(12) Patent Application Publication
(10) Pub. No.: US 2025/0306820 A1
(43) Pub. Date: Oct. 2, 2025

(54) SERVER, PRINT SYSTEM, INFORMATION PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Yasuhiro FURUTA, SHIMOSUWA-MACHI (JP)

(21) Appl. No.: 19/091,247

(22) Filed: Mar. 26, 2025

(30) Foreign Application Priority Data
Mar. 28, 2024 (JP) 2024-053128

(51) Int. Cl. G06F 3/12

(52) U.S. Cl. CPC G06F 3/1222; G06F 3/1232; G06F 3/1238

(57) ABSTRACT

A relay server includes a capability information controller configured to acquire, from a second print service system, capability information of an image forming device selected by using a second terminal device and transmit the capability information to the second terminal device and a print controller configured to receive, from the second terminal device, print setting information corresponding to the capability information and request the second print service system to perform printing of print data corresponding to print setting information by the image forming device selected by using the second terminal device.

The present application is based on, and claims priority from JP Application Serial Number 2024-053128, filed Mar. 28, 2024, the disclosure of which is hereby incorporated by reference herein in its entirety.

### BACKGROUND

### 1. Technical Field

The present disclosure relates to a server, a print system, an information processing method, and a non-transitory computer-readable storage medium storing a program.

### 2. Related Art

A technique of performing printing using a printer connected to a network is known. For example, JP-A-2016-45683 discloses one system including a printing device and a printing server. In this technique, after transmitting print data to the printing server, a user reads a code image attached to the printing device with a terminal device and designates a printing device to be used. Accordingly, printing is performed in the designated printing device.

JP-A-2016-45683 is an example of the related art.

In JP-A-2016-45683, when a plurality of systems providing a print service cooperate to execute printing, a print setting corresponding to a printer cannot be changed and convenience is deteriorated.

### SUMMARY

There is provided a server connected to a first print service system that receives print data from a first user terminal and a second print service system that is connected to a plurality of image forming devices and instructs an image forming device selected by using a second user terminal among the plurality of image forming devices to print the print data, the server including:
a capability information control unit configured to acquire, from the second print service system, capability information of the image forming device selected by using the second user terminal and transmit the capability information to the second user terminal; and
a print control unit configured to receive, from the second user terminal, print setting information corresponding to the capability information and request the second print service system to perform printing of the print data corresponding to print setting information by the image forming device selected by using the second user terminal.

There is provided a print system including:
a plurality of image forming devices; and
a server connected to a first print service system that receives print data from a first user terminal and a second print service system that is connected to the plurality of image forming devices and instructs an image forming device selected by using a second user terminal among the plurality of image forming devices to print the print data,
the server including:
   a capability information control unit configured to acquire, from the second print service system, capability information of the image forming device selected by using the second user terminal and transmit the capability information to the second user terminal; and
   a print control unit configured to receive, from the second user terminal, print setting information corresponding to the capability information and request the second print service system to perform printing of the print data corresponding to print setting information by the image forming device selected by using the second user terminal.

There is provided an information processing method including a server connected to a first print service system that receives print data from a first user terminal and a second print service system that is connected to a plurality of image forming devices and instructs an image forming device selected by using a second user terminal among the plurality of image forming devices to print the print data:
acquiring, from the second print service system, capability information of the image forming device selected by using the second user terminal and transmitting the capability information to the second user terminal; and
receiving, from the second user terminal, print setting information corresponding to the capability information and requesting the second print service system to perform printing of the print data corresponding to the print setting information by the image forming device selected by using the second user terminal.

There is provided a non-transitory computer-readable storage medium storing a program, the program causing a server connected to a first print service system that receives print data from a first user terminal and a second print service system that is connected to a plurality of image forming devices and instructs an image forming device selected by using a second user terminal among the plurality of image forming devices to print the print data to function as:
a capability information control unit configured to acquire, from the second print service system, capability information of the image forming device selected by using the second user terminal and transmit the capability information to the second user terminal; and
a print control unit configured to receive, from the second user terminal, print setting information corresponding to the capability information and request the second print service system to perform printing of the print data corresponding to print setting information by the image forming device selected by using the second user terminal.

### BRIEF DESCRIPTION OF THE DRAWINGS

FIG. 1 is a block diagram illustrating an example of a configuration of a print system according to an embodiment.

FIG. 2 is a block diagram illustrating an example of a configuration of a first print service system according to the embodiment.

FIG. 3 is a block diagram illustrating an example of a configuration of a second print service system according to the embodiment.

FIG. 4 is a block diagram illustrating an example of a configuration of a relay server according to the embodiment.

FIG. 5 is a block diagram illustrating an example of a configuration of a first terminal device according to the embodiment.

FIG. 6 is a block diagram illustrating an example of a configuration of a second terminal device according to the embodiment.

FIG. 7 is a block diagram illustrating an example of a configuration of an image forming device according to the embodiment.

FIG. 8A is a sequence chart illustrating an example of a flow of registration processing for a virtual printer for code.

FIG. 8B is a sequence chart illustrating the example of the flow of the registration processing for the virtual printer for code.

FIG. 8C is a sequence chart illustrating the example of the flow of the registration processing for the virtual printer for code.

FIG. 9 is a sequence chart illustrating an example of a flow of setting processing of a rule concerning use of the image forming device.

FIG. 10 is a sequence chart illustrating an example of a flow of processing in which the print system receives print data.

FIG. 11A is a sequence chart illustrating an example of a flow of print processing.

FIG. 11B is a sequence chart illustrating the example of the flow of the print processing.

FIG. 11C is a sequence chart illustrating the example of the flow of the print processing.

FIG. 11D is a sequence chart illustrating the example of the flow of the print processing.

FIG. 11E is a sequence chart illustrating the example of the flow of the print processing.

FIG. 11F is a sequence chart illustrating the example of the flow of the print processing.

FIG. 11G is a sequence chart illustrating the example of the flow of the print processing.

FIG. 11H is a sequence chart illustrating the example of the flow of the print processing.

FIG. 11I is a sequence chart illustrating an example of the flow of the print processing.

### DESCRIPTION OF EMBODIMENT

An embodiment is explained below with reference to the drawings. To clarify the explanation, the following explanation and the drawings are omitted or simplified as appropriate. In the drawings, the same elements are denoted by the same reference numerals and signs and redundant explanation of the elements is omitted according to necessity.

As explained above, it is preferable that, even when different systems that provide print services cooperate with each other, authentication printing is implemented in order to prevent the systems from being used in an unauthorized manner to perform printing. Therefore, in the present embodiment, a technique for implementing authentication printing in a print system in which different systems that provide print services cooperate with one another is explained. In the present disclosure, in addition to such a technique, the following techniques are further implemented. That is, in the present disclosure, in the print system in which the different systems that provide print services cooperate with one another, a technique in which a user designates an image forming device to be used for printing using a code image attached to the image forming device is further implemented. In the present disclosure, in the print system in which the different systems that provide print services cooperate with one another, a technique for, after the user has designated the image forming device to be used for printing, changing a print setting corresponding to the designated image forming device is implemented.

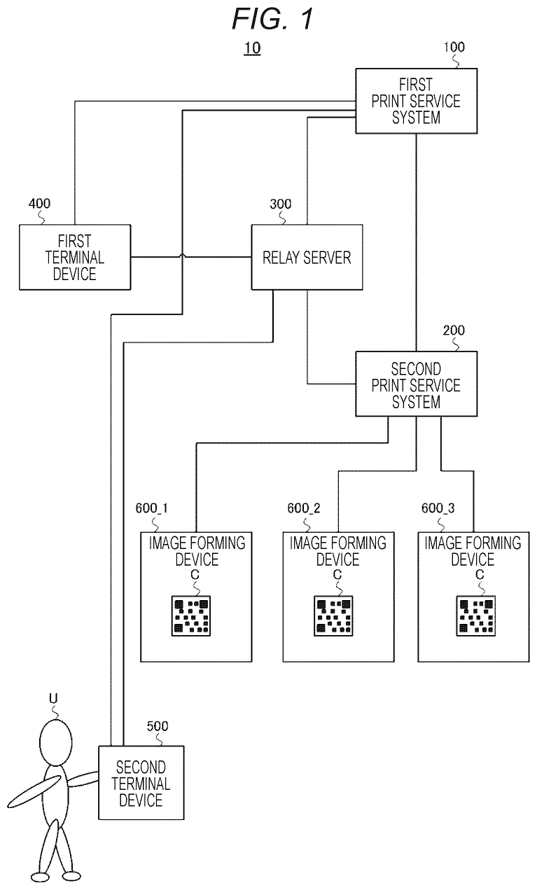

FIG. 1 is a block diagram illustrating an example of a configuration of a print system 10 according to an embodiment. The print system 10 includes a first print service system 100, a second print service system 200, and a relay server 300. FIG. 1 also illustrates a first terminal device 400, a second terminal device 500, and image forming devices 600_1, 600_2, and 600_3 that are communicably connected to the print system 10. In the following explanation, when the image forming devices 600_1, 600_2, and 600_3 are referred to without being particularly distinguished, the image forming devices 600_1, 600_2, and 600_3 are referred to as image forming devices 600. FIG. 1 also illustrates a user U who carries the second terminal device 500 and moves to the front of the image forming device 600 that the user U desires to use.

A system including the first terminal device 400 may be referred to as print system 10. Similarly, a system including the second terminal device 500 may be referred to as print system 10, and a system including the image forming devices 600 may be referred to as print system 10.

The first print service system 100 and the second print service system 200 are systems that provide print services on the cloud. Here, the first print service system 100 is a system for a service provided by a first vendor and the second print service system 200 is a system for a service provided by a second vendor different from the first vendor. For example, the second vendor is a vendor that manufactures the image forming devices 600.

The image forming devices 600 are devices including a function of performing print processing. In the present embodiment, the image forming devices 600 are, specifically, printers. In the present embodiment, the image forming devices 600 are registered in the second print service system 200 in advance as devices capable of executing print processing for a print job managed by the second print service system 200.

The first terminal device 400 and the second terminal device 500 are client terminals such as a personal computer (PC), a smartphone, and a tablet terminal. In particular, the second terminal device 500 is preferably a mobile terminal that can be easily carried by the user U. The first terminal device 400 and the second terminal device 500 may be the same terminal device. The first terminal device 400 is a specific example of a first user terminal. The second terminal device 500 is a specific example of a second user terminal.

The relay server 300 is a specific example of a server that mediates between the first print service system 100 and the second print service system 200. The relay server 300 relays processing in the print system 10.

Code images C are attached to the image forming devices 600. The code images C include at least identification information for uniquely identifying the image forming devices 600. In the present embodiment, the code images C further include information indicating a predetermined access destination. Specifically, the information indicating the predetermined access destination is, for example, a uniform resource locator (URL) for accessing the relay server 300. The code images C only have to be images obtained by encoding the information explained above and may be barcodes or may be two-dimensional codes such as a QR code (registered trademark). The code image C attached to the image forming device 600 that the user U desires to use is read by the second terminal device 500 according to operation of the user U.

In the present embodiment, the image forming devices 600 may be devices managed by a specific organization. That is, the image forming devices 600 may be devices belonging to the specific organization. The image forming devices 600 may be managed by separate organizations. For example, the image forming devices 600_1 and 600_2 may be managed by a first organization and the image forming device 600_3 may be managed by a second organization.

As illustrated in FIG. 1, the first print service system 100 and the second print service system 200 are communicably connected. The relay server 300 is communicably connected to each of the first print service system 100 and the second print service system 200. The plurality of image forming devices 600 are communicably connected to the second print service system 200. The first terminal device 400 and the second terminal device 500 are communicably connected to at least the first print service system 100 and the relay server 300. In addition to the connection relationship explained above, a further connection relationship may be present among the elements. For example, the first terminal device 400 and the second terminal device 500 may be communicably connected to the second print service system 200.

Although three image forming devices 600 are illustrated as an example in FIG. 1, the number of image forming devices 600 that use the print system 10 is optional. Similarly, although one first terminal device 400 and one second terminal device 500 are illustrated as an example, the numbers of the first terminal devices 400 and the second terminal devices 500 that use the print system 10 are optional.

As explained above, both of the first print service system 100 and the second print service system 200 are systems that provide print services on the cloud. For this reason, when a printer is registered in a print service system, printing by the printer through the print service system is possible. However, when the printer is not a model adapted to a protocol used by the print service system, the printer cannot be directly registered in the print service system. In the present embodiment, the image forming devices 600 are adapted to a protocol used by the second print service system 200 and can be directly registered in the second print service system 200. However, the image forming devices 600 are not always adapted to a protocol used by the first print service system 100.

For this reason, in the present embodiment, printing by the image forming devices 600 via the first print service system 100 is performed by associating a printer registered as a virtual printer (a virtual device) in the first print service system 100 with any one of the plurality of image forming devices 600 registered in the second print service system 200. The association is performed by the relay server 300. In some case, although the image forming device 600 is a model not adapted to the protocol of the first print service system 100, the user desires printing by the image forming device 600 using a print service provided by the first print service system 100. Examples of such a case include a case in which installation of a printer driver for the image forming device 600, which is required in the second print service system 200, is unnecessary for the first print service system 100. Naturally, the user may desire, for any other reason, printing by the image forming device 600 using the first print service system 100. In such a case, the relay server 300 needs to associate any one of the plurality of image forming devices 600 registered in the second print service system 200 with a virtual printer registered in the first print service system 100. Whereas the first print service system 100 provides a print service using, for example, the Internet printing protocol shared infrastructure extensions (IPP-Infra) as the protocol explained above, the second print service system 200 provides a print service without using the protocol.

In the present embodiment, the user U moves to the front of any one of the plurality of image forming devices 600 and reads the code image C attached to the image forming device 600 with the second terminal device 500, whereby the image forming device 600 that the user U uses for printing is designated. That is, in the present embodiment, an output destination of a print is designated by reading the code image C. For this reason, in the present embodiment, as explained below, the relay server 300 registers, in the first print service system 100, in advance, a dedicated virtual printer for a print job in which an output destination is designated by reading the code image C and, when the code image C is read, the dedicated virtual printer and the image forming device 600 specified from the read code image C are associated with each other.

In the present embodiment, as explained below, the relay server 300 requires, as a condition for processing a print request from the user U, authentication completion information indicating that authentication of the user U by the first print service system 100 has been completed. Accordingly, authentication printing is implemented in the print system 10 with which a different system providing a print service cooperates.

A specific configuration and processing of the print system 10 are explained below. Configurations of the first print service system 100, the second print service system 200, the relay server 300, the first terminal device 400, the second terminal device 500, and the image forming device 600 are explained with reference to the drawings.

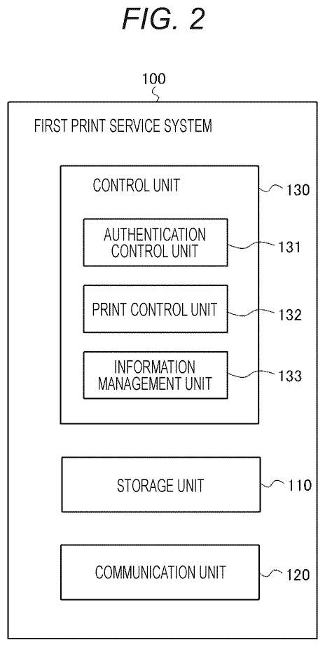

FIG. 2 is a block diagram illustrating an example of the configuration of the first print service system 100. In the example illustrated in FIG. 2, although an example in which the first print service system 100 includes one server is illustrated, the first print service system 100 may include a plurality of servers.

As illustrated in FIG. 2, the first print service system 100 includes a storage unit 110, a communication unit 120, and a control unit 130.

The storage unit 110 is a storage device that stores a program for implementing processing of the control unit 130 and data used for processing of the first print service system 100. The storage device may be a nonvolatile storage device such as a hard disk or a flash memory or may include a memory such as a random access memory (RAM). The storage unit 110 can include a database. The communication unit 120 is a communication interface for communicating with other devices such as the second print service system 200, the relay server 300, the first terminal device 400, and the second terminal device 500 via a wireless network or a wired network. The control unit 130 is a processor such as a central processing unit (CPU) that controls the components of the first print service system 100. The control unit 130 may include a plurality of processors. The control unit 130 reads a program into the memory and executes the program. Accordingly, the control unit 130 implements functions of an authentication control unit 131, a print control unit 132, and an information management unit 133.

The authentication control unit 131 performs various kinds of processing concerning authentication of a user who uses the first print service system 100. The user of the first print service system 100 includes a user serving as an administrator and a user serving as a general user who is not the administrator. The user serving as the administrator can also be referred to as user having administrator authority. The user serving as the general user can also be referred to as user having user authority that is authority more limited than the administrator authority. In the present embodiment, it is assumed that these users are registered in advance in the first print service system 100. The authentication control unit 131 provides a page for authentication to the first terminal device 400 or the second terminal device 500, authenticates the administrator or the general user, and issues a token necessary for accessing the first print service system 100. Specific processing of the authentication control unit 131 in the present embodiment is explained with reference to a sequence chart referred to below.

The print control unit 132 performs control processing for executing printing by the printer registered in the first print service system 100. In the present embodiment, the print control unit 132 performs control processing at the time when printing is performed by the image forming device 600 via a virtual printer registered in the first print service system 100. However, the print control unit 132 may also perform the control processing at the time when printing is performed by a physical printer that is not registered as the virtual printer but is directly registered in the first print service system 100. Specifically, in the present embodiment, the print control unit 132 performs processing of receiving a print request from the first terminal device 400, processing of transmitting information required for performing printing conforming to the print request to the relay server 300, processing of notifying a job state to the first terminal device 400 or the second terminal device 500, and the like. Specific processing of the print control unit 132 in the present embodiment is explained with reference to a sequence chart referred to below.

The information management unit 133 performs processing of registering a printer in the first print service system 100. The information management unit 133 manages information concerning a user registered in the first print service system 100. The information concerning the user includes, for example, authentication information of the user and identification information (an organization ID) of a user organization that is an organization to which the user belongs. The authentication information of the user includes identification information (a user ID) of the user and information for collation such as a password or a personal identification number. The information management unit 133 may manage information concerning a printer registered in the first print service system 100. For example, the information management unit 133 may manage a printer name, a printer ID, capability information, shared information, and the like of the registered printer. The information management unit 133 may further perform processing of registering a user in the first print service system 100. Specific processing of the information management unit 133 in the present embodiment is explained with reference to a sequence chart referred to below.

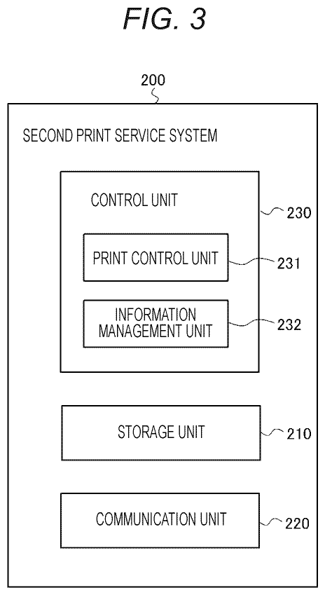

FIG. 3 is a block diagram illustrating an example of the configuration of the second print service system 200. In the example illustrated in FIG. 3, although an example in which the second print service system 200 includes one server is illustrated, the second print service system 200 may include a plurality of servers.

As illustrated in FIG. 3, the second print service system 200 includes a storage unit 210, a communication unit 220, and a control unit 230.

The storage unit 210 is a storage device that stores a program for implementing processing of the control unit 230 and data used for processing of the second print service system 200. The storage device may be a nonvolatile storage device such as a hard disk or a flash memory and may include a memory such as a RAM. The storage unit 210 can also include a database. The communication unit 220 is a communication interface for communicating with other devices such as the first print service system 100, the relay server 300, and the image forming device 600 via a wireless network or a wired network. The control unit 230 is a processor such as a CPU that controls the components of the second print service system 200. The control unit 230 may include a plurality of processors. The control unit 230 reads the program into the memory and executes the program. Accordingly, the control unit 230 implements functions of a print control unit 231 and an information management unit 232.

The print control unit 231 performs control processing for executing printing by the image forming device 600 that is a printer registered in the second print service system 200. Specifically, in the present embodiment, the print control unit 231 performs processing of receiving a print request from the relay server 300, processing of transmitting information required for performing printing conforming to the print request to the image forming device 600, processing of notifying a job state to the relay server 300, processing of transmitting capability information to the second terminal device 500, and the like. Specific processing of the print control unit 231 in the present embodiment is explained with reference to a sequence chart referred to below.

The information management unit 232 manages information registered in the second print service system 200. For example, the information management unit 232 manages information concerning the image forming device 600 that is the printer registered in the second print service system 200. The information management unit 232 manages, for each image forming device 600, attribute information such as a printer name, capability information, and a default print setting as initial print setting information corresponding to the capability information of the registered image forming device 600 as information concerning the image forming device 600, that is, information concerning the printer. The information management unit 232 may perform processing of registering the image forming device 600 in the second print service system 200.

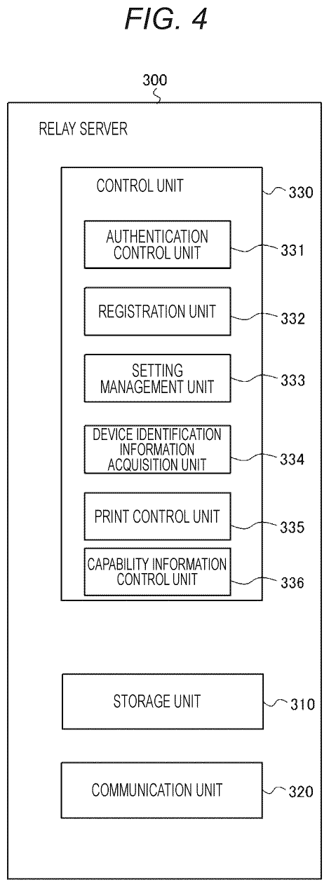

FIG. 4 is a block diagram illustrating an example of the configuration of the relay server 300. In the example illustrated in FIG. 4, although an example in which the relay server 300 includes one server is illustrated, the relay server 300 may include a plurality of servers. The relay server 300 may be referred to as server.

As illustrated in FIG. 4, the relay server 300 includes a storage unit 310, a communication unit 320, and a control unit 330.

The storage unit 310 is a storage device that stores a program for implementing processing of the control unit 330 and data used for processing of the relay server 300. The storage device may be a nonvolatile storage device such as a hard disk or a flash memory and may include a memory such as a RAM. The storage unit 310 can include a database. The storage unit 310 stores, for example, a correspondence relationship between a virtual printer and the image forming device 600, setting information concerning use of the image forming device 600, and a correspondence relationship between a print job of the first print service system 100 and a print job of the second print service system 200. The setting information concerning the use of the image forming device 600 includes a rule concerning the use of the image forming device 600 determined in advance by the administrator or the like. The setting information concerning the use of the image forming device 600 may include a user instruction concerning application of the rule explained above. The storage unit 310 can store different rules for each user organization. The storage unit 310 may store different instructions for each user. The communication unit 320 is a communication interface for communicating with the other devices such as the first print service system 100, the second print service system 200, the first terminal device 400, and the second terminal device 500 via a wireless network or a wired network. The control unit 330 is a processor such as a CPU that controls the components of the relay server 300. The control unit 330 may include a plurality of processors. The control unit 330 reads the program into the memory and executes the program. Accordingly, the control unit 330 implements functions of an authentication control unit 331, a registration unit 332, a setting management unit 333, a device identification information acquisition unit 334, a print control unit 335, and a capability information control unit 336.

The authentication control unit 331 performs various kinds of processing for receiving authentication by the first print service system 100. In particular, the authentication control unit 331 performs processing of acquiring authentication completion information. Here, the authentication completion information is information indicating that authentication by the first print service system 100 for authentication information of the user input to the first terminal device 400 or the second terminal device 500 has been completed. In the present embodiment, the authentication completion information is, specifically, a token necessary for accessing the first print service system 100 (hereinafter referred to as access token). Specific processing of the authentication control unit 331 in the present embodiment is explained with reference to a sequence chart referred to below.

The registration unit 332 performs processing of registering a virtual printer (a virtual device) in the first print service system 100. In particular, in order to enable designation of an output destination by reading of the code image C in the print system 10 with which a different system providing a print service cooperates, the registration unit 332 registers a dedicated virtual printer for a print job in which the designation of the output destination by the reading of the code image C is performed. In the following explanation, such a virtual printer is referred to as virtual printer for code.

The image forming device 600 associated with the virtual printer for code fluctuates according to the code image C of which image forming device 600 among the plurality of image forming devices 600 is read by the user using the second terminal device 500. The association of the image forming device 600 with the virtual printer for code is temporary. New association is set every time printing operation is performed, that is, every time an output destination is designated using the code image C. For this reason, the virtual printer for code can also be considered a virtual printer that can be associated with any image forming device 600. The association between the virtual printer for code and the image forming device 600 is performed by the print control unit 335, as explained below. Instead of designating the image forming device 600 as the output destination using the code image C, a virtual printer registered in the first print service system 100 may be fixedly associated with any image forming devices 600 such that an output by the specific image forming device 600 can be designated when making a print request to the first print service system 100.

In the present embodiment, the first print service system 100 performs virtual printer registration processing only in response to a registration request with administrator authority, and does not approve registration in response to a registration request without administrator authority. For this reason, the registration unit 332 performs, using qualification information equivalent to the administrator authority, processing of registering a virtual printer in the first print service system 100. As explained above, in the present embodiment, the administrator authority is required to execute registration processing. However, the administrator authority may not be always required. Specific processing of the registration unit 332 in the present embodiment is explained with reference to a sequence chart referred to below.

The setting management unit 333 performs processing of managing a setting concerning use of the image forming device 600. The setting management unit 333 generates a rule concerning the use of the image forming device 600 based on an instruction from the user serving as the administrator. The rule is generated for each user organization based on an instruction from an administrator of the organization. For this reason, the setting management unit 333 generates a different rule for each user organization. The rule is generated for each of the image forming devices 600 for each user organization. That is, the rule concerning the use is set for each user organization and for each image forming device 600. The administrator may instruct to generate a common rule for all of the image forming devices 600 managed by the same organization. That is, the rule concerning the use may be set for each organization that manages the image forming device 600. In the present embodiment, the rule is applied when any user belonging to the user organization to which the administrator who instructs to generate the rule belongs uses the image forming device 600. In the present embodiment, the rule is generated based on an instruction of the administrator of the user organization to which the user to whom the rule applies belongs. However, the rule may not always be generated based on such an instruction of the administrator. The setting management unit 333 stores the generated rule in the storage unit 310 as setting information concerning the use of the image forming device 600.

Several examples of the rule to be generated are explained below. The rule to be generated is not limited to the following.

<Rule 1>: Use of the image forming device 600 that is a target of the rule is prohibited.

In the case of the rule 1, the user who performs the printing operation cannot use the image forming device 600 that is the application target of the rule.

<Rule 2>: Notification for warning the use of the image forming device 600 that is the target of the rule is always performed. The user who performs the printing operation selects whether to use the image forming device 600.

In the case of the rule 2, after checking the warning every time, the user who performs the printing operation determines whether to use the image forming device 600 to which the rule is applied.

<Rule 3>: Notification for warning the use of the image forming device 600 that is the target of the rule is basically performed. The warning for the image forming device 600 can also be omitted based on an instruction from the user. The user who performs the printing operation selects whether to use the image forming device 600.

In the case of the rule 3, after checking the warning once, the user who performs the printing operation determines whether to use the image forming device 600 to which the rule is applied. When determining that the image forming device 600 may be used, the user can also instruct the relay server 300 not to notify the warning for the next and subsequent use of the image forming device 600. However, the user may not give such an instruction.

<Rule 4>: Notification for warning the use of the image forming device 600 that is the target of the rule is basically performed. Based on an instruction from the user, a warning for the image forming device 600 or a warning for all the image forming devices 600 managed by the same organization as the organization managing the image forming device 600 can be omitted. The user who performs the printing operation selects whether to use the image forming device 600.

In the case of the rule 4, after checking the warning once, the user who performs the printing operation determines whether to use the image forming device 600 to which the rule is applied. When determining that the image forming device 600 may be used, the user can instruct the relay server 300 not to notify the warning for the next and subsequent use of the image forming device 600 or can instruct the relay server 300 not to notify the warning for the next and subsequent use of all the image forming devices 600 managed by the same organization as the organization that manages the image forming device 600. However, the user may not give such an instruction.

<Rule 5>: Use of the image forming device 600 that is the target of the rule is permitted.

In the case of the rule 5, the user who performs the printing operation can freely use, without being notified of a warning for use of the image forming device 600 that is the application target of the rule, the image forming device 600.

For example, an administrator of a certain user organization gives an instruction to generate the rule 5 for the image forming device 600 managed by this user organization because it is considered that the image forming device 600 managed by the own organization is a safe output destination. On the other hand, the administrator considers that the image forming devices 600 not managed by the own organization are not always safe output destinations and gives an instruction to generate any one of the rules 1 to 4 for the image forming devices 600. In this case, the administrator determines which of the rules 1 to 4 should be generated considering safety degrees of the image forming devices 600.

The setting management unit 333 manages, in association with identification information of the user and identification information of the target image forming device 600, the instruction concerning the application of the rule from the user who has performed the printing operation. For example, the setting management unit 333 manages the instruction concerning the warning notification together with the identification information of the user and the image forming device 600. When the user who has received the warning gives an instruction to perform setting to always prohibit the use, the setting management unit 333 may manage the instruction in association with the identification information of the user and the image forming device 600. The setting management unit 333 stores the received instruction as setting information concerning the use of the image forming device 600 in the storage unit 310 in correlation with the identification information of the user and the image forming device 600. When an instruction target is all the image forming devices 600 belonging to a specific user organization, the setting management unit 333 may store the instruction in the storage unit 310 in correlation with identification information of the organization.

The device identification information acquisition unit 334 acquires the identification information of the image forming device 600 included in the code image C attached to the image forming device 600. More specifically, the device identification information acquisition unit 334 acquires, from the second terminal device 500, the identification information of the image forming device 600 included in the code image C read by the second terminal device 500.

The capability information control unit 336 acquires, from the second print service system 200, capability information of the image forming device 600 selected as the output destination using the second terminal device 500. More specifically, the capability information control unit 336 acquires, from the second print service system 200, the capability information of the image forming device 600 selected using the second terminal device 500 and a default print setting serving as initial print setting information corresponding to the capability information. Then, the capability information control unit 336 transmits the acquired capability information to the second terminal device 500. More specifically, the capability information control unit 336 transmits the default print setting together with the acquired capability information to the second terminal device 500.

The print control unit 335 performs control processing for executing printing by the image forming device 600 that is the printer registered in the second print service system 200. In other words, the print control unit 335 performs control processing for executing printing by the image forming device 600 associated with the virtual printer registered in the first print service system 100. At this time, the print control unit 335 associates the virtual printer for code and the image forming device 600 with each other based on the identification information of the image forming device 600 included in the code image C. The print control unit 335 performs processing of acquiring information required for performing printing from the first print service system 100, processing of transmitting a print request to the second print service system 200 based on the information, processing of notifying a job state to the first print service system 100, and the like.

In particular, in the present embodiment, the print control unit 335 performs the following processing. The print control unit 335 acquires a print job for the user from the first print service system 100 using the authentication completion information acquired by the authentication control unit 331 and transmits, to the second print service system 200, a request to cause the image forming device 600 to execute printing for the print job. For this reason, when the authentication completion information cannot be acquired, the print control unit 335 does not acquire a print job for the user from the first print service system 100. Therefore, in such a case, printing is not executed. As explained above, in the present embodiment, authentication printing using authentication by the first print service system 100 is implemented in printing in the image forming device 600 connected to the second print service system 200. For this reason, unauthorized use of the system can be prevented.

In particular, when the device identification information acquisition unit 334 acquires the identification information of the image forming device 600 included in the code image C, the print control unit 335 acquires, from the first print service system 100, print jobs in which use of the virtual printer for code registered in the first print service system 100 is designated. More specifically, the print control unit 335 acquires a print job corresponding to the user who has performed the printing operation among such print jobs. The print control unit 335 transmits, to the second print service system 200, a request to cause the image forming device 600 identified by the identification information acquired by the device identification information acquisition unit 334 to execute printing for the print job. For this reason, in the present embodiment, also in a print system with which a different system providing a print service cooperates, a user can designate, using the code image C attached to the image forming device 600, the image forming device 600 to be used for printing.

The print control unit 335 refers to a rule concerning use of the image forming device 600 identified by the identification information acquired by the device identification information acquisition unit 334, the rule being applied to a user who performs the printing operation (a user corresponding to a processing target print job). Specifically, the print control unit 335 refers to the setting information stored in the storage unit 310. Then, the print control unit 335 executes, according to the referred rule, processing of controlling the use, by the user, of the image forming device 600 identified by the identification information. Accordingly, even when various users use the print system 10, the use of the image forming device 600 can be controlled according to rules corresponding to the users.

The processing of controlling the use by the user includes processing of prohibiting the use of the image forming device 600 identified by the identification information acquired by the device identification information acquisition unit 334. In this case, the print control unit 335 may transmit, to the second terminal device 500, a notification indicating that the use of the image forming device 600 is prohibited. The processing of controlling the use by the user includes processing of transmitting, to the second terminal device 500, a notification for warning the use of the image forming device 600 identified by the identification information acquired by the device identification information acquisition unit 334. The print control unit 335 executes these kinds of processing according to the setting information stored in the storage unit 310, that is, the rule generated by the setting management unit 333.

For example, the following processing is performed based on the rules 1 to 5 explained above. For example, when the device identification information acquisition unit 334 has acquired the identification information of the image forming device 600 for which the rule 1 is set, the print control unit 335 transmits, to the second terminal device 500, a notification indicating that the use of the image forming device 600 is prohibited.

For example, when the device identification information acquisition unit 334 has acquired the identification information of the image forming device 600 for which any one of the rules 2 to 4 is set, the print control unit 335 transmits, to the second terminal device 500, a notification for warning the use of the image forming device 600. In response to the notice, the user transmits, to the relay server 300, via the second terminal device 500, an instruction to select whether to use the image forming device 600. The user who has received the warning for the image forming device 600 to which the rule 3 is applied can also give an instruction to omit the next and subsequent warnings for the image forming device 600. Similarly, the user who has received the warning for the image forming device 600 to which the rule 4 is applied can give an instruction to omit the next and subsequent warnings for all the image forming devices 600 belonging to the same organization to which the image forming device 600 belongs.

The user who has received the warning for the image forming device 600 to which any one of the rules 2 to 4 is applied can select, as an instruction to reject the use of the image forming device 600 that is the target of the warning, an instruction to continuously reject the use or an instruction to temporarily reject the use. The instruction to temporarily reject the use is an instruction not to use only this time. The instruction to continuously reject the use is an instruction not to use not only this time but also the next and subsequent times. The instruction to continuously reject the use may be an instruction to continuously reject the use of the image forming device 600 that is the target of the warning or an instruction to continuously reject the use of all the image forming devices 600 managed by the same organization as an organization that manages the image forming device 600 that is the target of the warning.

For example, when the device identification information acquisition unit 334 has acquired the identification information of the image forming device 600 for which the rule 5 is set, the print control unit 335 permits the use of the image forming device 600 without warning the use.

As explained above, in the present embodiment, the print control unit 335 restricts the use of the image forming device 600 according to a predetermined rule. For this reason, the image forming device 600, whose safety is not sufficiently confirmed, can be prevented from being used without any attention being paid by the user.

For example, in a print system in which an output destination can be designated using the code image C, when a malicious person or the like attaches anew, to the image forming device 600_1, the code image C attached to the image forming device 600_2, a print is likely to be stolen. The user who has read the code image C of the image forming device 600_1 with the second terminal device 500 waits for the print to be output from the image forming device 600_1 in front of the user. However, actually, the code image C including the identification information of the image forming device 600_2 is read. Therefore, the print is output from the image forming device 600_2. In this case, the malicious person can obtain the print output from the image forming device 600_2. However, in the present embodiment, as explained above, such a risk can be reduced by setting, for example, any one of the rules 1 to 4 for the image forming device 600 whose safety is not sufficiently confirmed. This is because, when the device identification information acquisition unit 334 has acquired the identification information of such an image forming device 600, the print control unit 335 can warn or prohibit the use of the image forming device 600. Thus, according to the present embodiment, the user can more safely designate, using the code image C attached to the image forming device 600, the image forming device 600 to be used for printing.

The notified warning preferably includes information indicating an organization that manages the image forming device 600 that is the warning target. In the following explanation, the organization that manages the image forming device 600 is referred to as device organization. Accordingly, the user can determine whether to use the image forming device 600 after determining whether the image forming device 600 is a device managed by a reliable organization. That is, the user can determine the safety of the image forming device 600 based on the organization that manages the image forming device 600. In the warning, it is preferable that the information indicating the device organization includes information, such as a domain name of the device organization, with which it can be confirmed that the presence of the organization is admitted by a public institution. The notified warning may include information indicating a legitimate installation location of the image forming device 600. Without being limited to such information, the print control unit 335 can include any information in the notified warning. For example, the notified warning may include information indicating whether the image forming device 600 is used for the first time by the user.

When acquiring a printing stop instruction from the second terminal device 500, the print control unit 335 transmits a printing stop request to the second print service system 200. Then, the print control unit 335 acquires, from the second print service system 200, information concerning whether the printing stop has been successful and notifies the information to the second terminal device 500. Accordingly, the user can check whether the printing stop has been successful. This brings about the following advantages in terms of security. Two cases are conceivable as a cause of a print not being immediately output from the image forming device 600 that the user assumes as an output destination. A first case is a case in which it takes time to execute print processing and a second case is a case in which the print has already been output from another image forming device 600. In the second case, before the user notices, the image forming device 600 different from the image forming device 600 in front of the user has already output the print and the print is likely to be stolen. In the present embodiment, if the user instructs the printing stop when the print is not output from the image forming device 600 in front of the user, it is notified to the second terminal device 500 whether the printing stop has been successful. When the second case explained above has occurred, since the print has already been output, it is notified that the printing stop has been unsuccessful. For this reason, the user can grasp that the second case has occurred. For this reason, an advantage in terms of security is obtained by the processing explained above. The print control unit 335 may notify the number of print jobs for which the printing stop has been successful or unsuccessful.

As explained above, when an instruction of a user concerning the application of the rule is present, the print control unit 335 executes processing of controlling the use of the image forming device 600 by the user according to the rule and the instruction. For example, the print control unit 335 acquires, from the second terminal device 500, an instruction as to whether to output the warning the next time as well for the image forming device 600 that is the warning target. The setting management unit 333 manages the acquired instruction as setting information. The print control unit 335 determines, according to the instruction, whether to output the warning as well the next time the user uses the image forming device 600. Specifically, in processing of a print job corresponding to the user, when the identification information of the image forming device 600 is acquired, the print control unit 335 determines, according to the instruction of the user, whether to output the warning. For example, when an instruction to omit a notification of a warning for the image forming device 600 for which the rule 3 or 4 is set is present, the print control unit 335 permits the use of the image forming device 600 without notifying of the warning. With such a configuration, since the user can be prevented from receiving a warning every time, the convenience for the user is improved.

For example, the print control unit 335 acquires, from the second terminal device 500, as an instruction to reject the use of the image forming device 600 that is the target of the warning, an instruction to continuously reject the use or an instruction to temporarily reject the use. The setting management unit 333 manages, as setting information, the instruction to continuously reject the use, that is, an instruction to set the use to be always prohibited. When the instruction to continuously reject the use is acquired, that is, when such an instruction is managed as the setting information, the print control unit 335 also prohibits the next and subsequent use of the image forming device 600 by the user. With such a configuration, since the image forming device 600 that the user does not desire to use can be surely prevented from being used in the future, the convenience for the user is improved.

As explained above, the instruction to omit the warning may be an instruction to prevent the warning from being notified in the future for all the image forming devices 600 managed by the same organization as the organization that manages the image forming device 600 that is the target of the warning. In this case, when the device identification information acquisition unit 334 has acquired identification information of any one of the image forming devices 600, the print control unit 335 omits a warning for the image forming device 600 and permits the use of the image forming device 600 regardless of a set rule. As explained above, the instruction to continuously reject the use may be the instruction to continuously reject the use of all the image forming devices 600 managed by the same organization as the organization that manages the image forming device 600 that is the target of the warning. In this case, when the device identification information acquisition unit 334 has acquired the identification information of any of the image forming devices 600, the print control unit 335 prohibits the next and subsequent use of the image forming device 600. As explained above, the print control unit 335 may acquire an instruction to reject the use of all the image forming devices 600 belonging to a specific device organization or an instruction to output a warning for all the image forming devices 600 belonging to the specific device organization and, in processing of a print job corresponding to a user who has given the instruction, apply the instruction to all the image forming devices 600 belonging to the device organization. Accordingly, the user can collectively perform setting for the image forming devices 600 managed by the specific organization. Therefore, the convenience for the user is improved.

The print control unit 335 receives print setting information corresponding to capability information from the second terminal device 500. Then, the print control unit 335 requests the second print service system 200 to print print data corresponding to the print setting information by the image forming device 600 selected using the second terminal device 500. Accordingly, when causing the image forming device 600 selected using the second terminal device 500 to execute the printing of the print data, the user can change detailed print setting specific to the image forming device 600 according to necessity. The print setting information corresponding to the capability information means that various functions of the image forming device 600 indicated by the capability information and a plurality of items of the print setting indicated by the print setting information respectively correspond to each other.

The print control unit 335 receives print data from the first print service system 100. The print control unit 335 processes the print data based on the print setting information. Then, the print control unit 335 transmits the processed print data to the second print service system 200. Accordingly, the print control unit 335 can execute processing of the print data corresponding to the print setting information in the relay server 300.

As explained above, instead of an implementation form in which the print control unit 335 receives print data from the first print service system 100, processes the print data, and transmits the processed print data to the second print service system 200, the print control unit 335 may transmit, to the second print service system 200, a print data URL that is an access destination for the second print service system 200 to acquire the print data from the first print service system 100. Accordingly, when the processing of the print data corresponding to the print setting information is unnecessary or when the processing of the print data corresponding to the print setting information can also be carried out in the second print service system 200 or the image forming device 600, the print control unit 335 can omit reception of the print data from the first print service system 100.

The print control unit 335 transmits the print setting information to the second print service system 200. Accordingly, the second print service system 200 can instruct the image forming device 600 to print the print data corresponding to the print setting information.

The capability information control unit 336 acquires, from the second print service system 200, together with the capability information of the image forming device 600 selected using the second terminal device 500, default print setting serving as initial print setting information corresponding to the capability information. Then, the capability information control unit 336 transmits the default print setting to the second terminal device 500 together with the capability information. Accordingly, the user U can easily carry out the print setting for the image forming device 600 by performing the print setting of the image forming device 600 because the print setting for the image forming device 600 can be carried out by partially changing the default print setting according to necessity instead of individually and specifically setting each item of the print setting for the image forming device 600 from the beginning.

The print setting information received by the print control unit 335 from the second terminal device 500 is information indicating that the print setting input or changed by using the second terminal device 500 is used or the print setting is used without being changed from the default print setting. Accordingly, when the user U determines that the default print setting is not suitable for printing the print data, the print setting for the image forming device 600 only has be individually and specifically input or changed for each item. When the user U determines that the default print setting is suitable for printing the print data, the print setting can be directly used without being changed from the default print setting.

Although the processing of the print control unit 335 is explained above, further specific processing of the print control unit 335 in the present embodiment is explained with reference to a sequence chart referred to below. Subsequently, the configuration of the first terminal device 400 is explained.

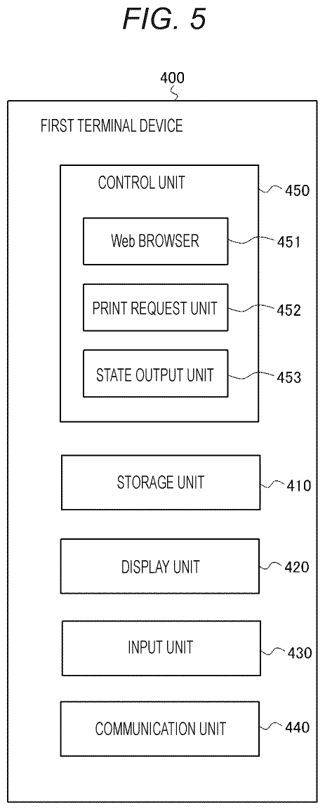

FIG. 5 is a block diagram illustrating an example of a configuration of the first terminal device 400. As illustrated in FIG. 5, the first terminal device 400 includes a storage unit 410, a display unit 420, an input unit 430, a communication unit 440, and a control unit 450.

The storage unit 410 is a storage device that stores a program for implementing processing of the control unit 450 and data used for processing of the first terminal device 400. The storage device may be a nonvolatile storage device such as a hard disk or a flash memory and may include a memory such as a RAM. The display unit 420 is a device for displaying information and is a display such as a flat panel display. The input unit 430 is a device that receives input operation from a user and is, for example, a keyboard or a mouse. The display unit 420 and the input unit 430 may be integrally configured by a touch panel or the like. The communication unit 440 is a communication interface for communicating with other devices such as the first print service system 100 and the relay server 300 via a wireless network or a wired network. The control unit 450 is a processor such as a CPU that controls the components of the first terminal device 400. The control unit 450 may include a plurality of processors. The control unit 450 reads a program into the memory and executes the program. Accordingly, the control unit 450 implements functions of a Web browser 451, a print request unit 452, and a state output unit 453.

The Web browser 451 is a publicly-known Web browser. In the present embodiment, the Web browser 451 performs processing of displaying a Web page provided from the first print service system 100 or the relay server 300 on the display unit 420, processing of transmitting input information for the Web page, and the like. Specific processing of the Web browser 451 in the present embodiment is explained with reference to a sequence chart referred to below.

The print request unit 452 performs processing of requesting printing according to operation from the user. In the present embodiment, in particular, the print request unit 452 requests the first print service system 100 to perform printing. Specific processing of the print request unit 452 in the present embodiment is explained with reference to a sequence chart referred to below.

The state output unit 453 performs processing of acquiring a job state explained below via the first print service system 100 and outputting the job state. In the present embodiment, the state output unit 453 outputs the job state to the display unit 420. However, the output does not always have to output by display. For example, the state output unit 453 may output the job state by voice or the like. The state output unit 453 may be provided in the first terminal device 400 as a function of the Web browser 451. Specific processing of the state output unit 453 in the present embodiment is explained with reference to a sequence chart referred to below.

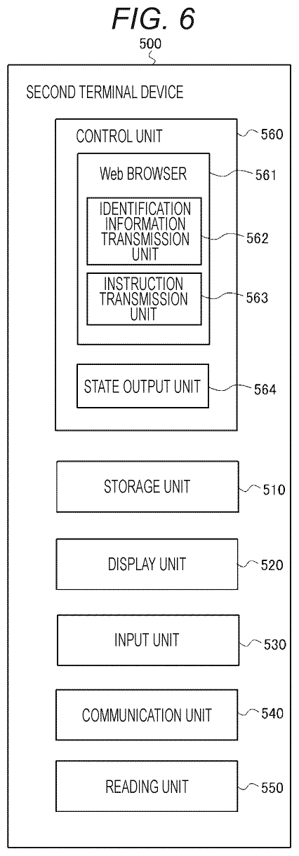

FIG. 6 is a block diagram illustrating an example of the configuration of the second terminal device 500. As illustrated in FIG. 5, the second terminal device 500 includes a storage unit 510, a display unit 520, an input unit 530, a communication unit 540, a reading unit 550, and a control unit 560.

The storage unit 510 is a storage device that stores a program for implementing processing of the control unit 560 and data used for processing of the second terminal device 500. The storage device may be a nonvolatile storage device such as a hard disk or a flash memory and may include a memory such as a RAM. The display unit 520 is a device for displaying information and is a display such as a flat panel display. The input unit 530 is a device that receives input operation from a user and is, for example, a keyboard or a mouse. As explained above, since the second terminal device 500 is preferably a mobile terminal, the display unit 520 and the input unit 530 are preferably integrally configured by a touch panel or the like. The communication unit 540 is a communication interface for communicating with the other devices such as the first print service system 100 and the relay server 300 via a wireless network or a wired network. The reading unit 550 is a device that reads the code image C attached to the image forming device 600 and is specifically, for example, a camera. The control unit 560 is a processor such as a CPU that controls the components of the second terminal device 500. The control unit 560 may include a plurality of processors. The control unit 560 reads a program into the memory and executes the program. Accordingly, the control unit 560 implements functions of a Web browser 561, an identification information transmission unit 562, an instruction transmission unit 563, and a state output unit 564.

The Web browser 561 is a publicly-known Web browser. In the present embodiment, the Web browser 561 performs processing of displaying a Web page provided from the first print service system 100 or the relay server 300 on the display unit 520, processing of transmitting input information for the Web page, and the like. In particular, in the present embodiment, the Web browser 561 functions as the identification information transmission unit 562. The identification information transmission unit 562 transmits, to the relay server 300, the identification information of the image forming device 600 included in the code image C read by the reading unit 550. In the present embodiment, the Web browser 561 functions as the instruction transmission unit 563. The instruction transmission unit 563 transmits, to the relay server 300, an instruction from the user input via the input unit 530. The instruction transmission unit 563 transmits, in particular, an instruction to select whether to use the image forming device 600 warned by the relay server 300, an instruction concerning the application of the rule explained above, an instruction to execute printing, an instruction to stop printing, and the like. Specific processing of the Web browser 561 in the present embodiment is explained with reference to a sequence chart referred to below.

The state output unit 564 performs processing for acquiring a job state explained below via the first print service system 100 and outputting the job state. In the present embodiment, the state output unit 564 outputs the job state to the display unit 520. However, the output may not always be output by display. For example, the state output unit 564 may output the job state by voice or the like. Specific processing of the state output unit 564 in the present embodiment is explained below with reference to a sequence chart referred to below.

In the configuration illustrated in FIG. 6, the identification information transmission unit 562 and the instruction transmission unit 563 are explained as the functions of the Web browser 561. However, the identification information transmission unit 562 and the instruction transmission unit 563 are not always provided as the functions of the Web browser 561. That is, the identification information transmission unit 562 and the instruction transmission unit 563 may be present in the second terminal device 500 as functions independent of the Web browser 561. The state output unit 564 may be provided in the second terminal device 500 as a function of the Web browser 561. The control unit 560 of the second terminal device 500 may include the same function as the print request unit 452 of the first terminal device 400.

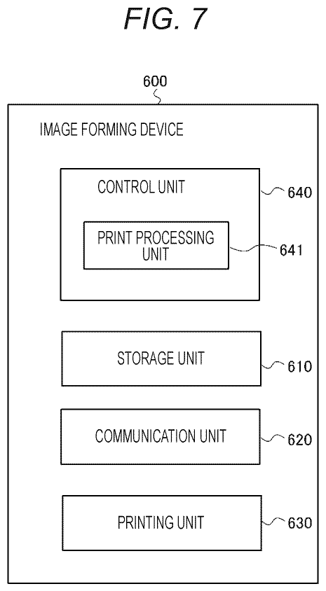

FIG. 7 is a block diagram illustrating an example of the configuration of the image forming device 600. As illustrated in FIG. 7, the image forming device 600 includes a storage unit 610, a communication unit 620, a printing unit 630, and a control unit 640.

The storage unit 610 is a storage device that stores a program for implementing processing of the control unit 640 and data used for processing of the image forming device 600. The storage device may be a nonvolatile storage device such as a hard disk or a flash memory and may include a memory such as a RAM. The communication unit 620 is a communication interface for communicating with the other devices such as the second print service system 200 via a wireless network or a wired network. The control unit 640 is a processor such as a CPU that controls the components of the image forming device 600. The control unit 640 may include a plurality of processors. The control unit 640 reads a program into the memory and executes the program. Accordingly, the control unit 640 implements a function of a print processing unit 641.

The print processing unit 641 performs processing of executing printing by the printing unit 630. The print processing unit 641 notifies a job state of a print job to the second print service system 200. Specific processing of the print processing unit 641 in the present embodiment is explained with reference to a sequence chart referred to below.

The printing unit 630 has a printing function for forming an image on a print medium such as paper. The printing unit 630 includes a print engine. The print engine is a mechanical component that executes printing of an image on the print medium using a color material. The print engine may include a mechanism for performing printing using ink with, for example, an inkjet scheme. Alternatively, the print engine may include a mechanism for printing using toner with, for example, electrophotography. The print engine may include a conveying mechanism that conveys the print medium.

The image forming device 600 may further include a user interface such as a touch panel display. In the present embodiment, as explained above, the image forming device 600 includes the printing unit 630 and includes a function of a printer. Therefore, the image forming device 600 is also referred to as printer.

Subsequently, a flow of processing of the print system 10 is explained with reference to a sequence chart.

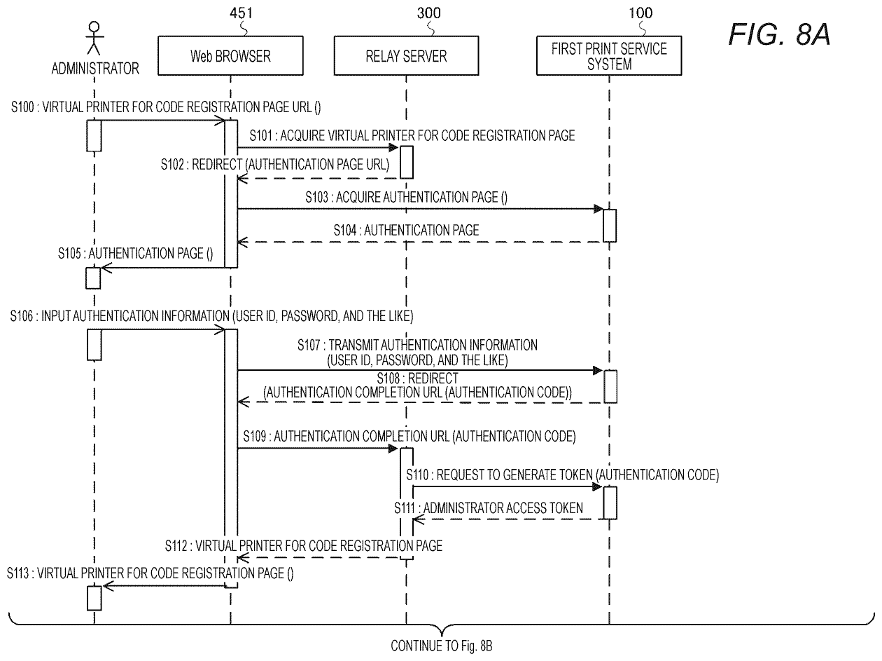

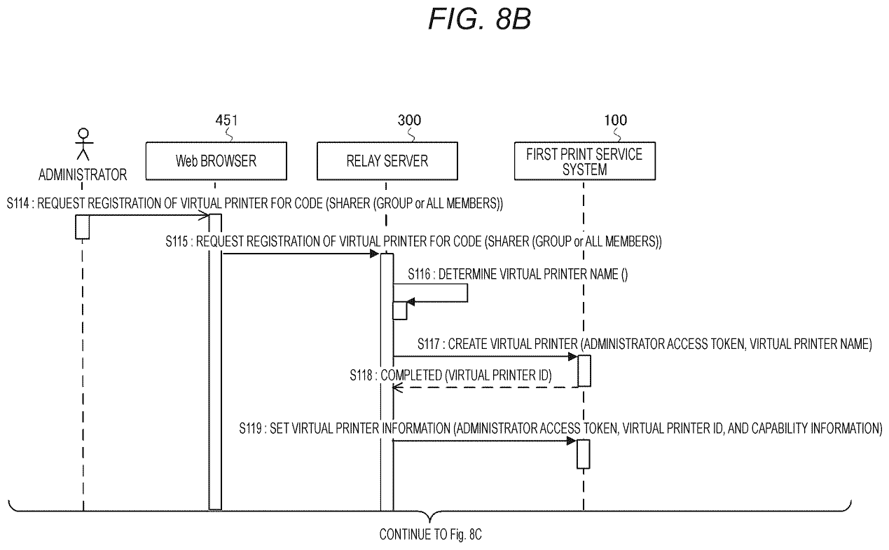

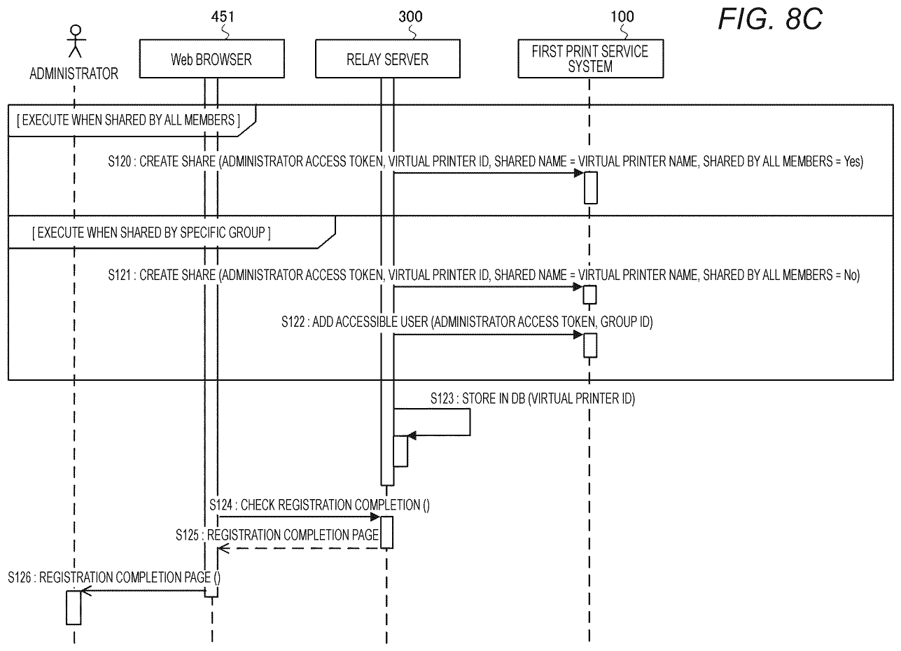

First, a flow of processing for registering a virtual printer for code in the first print service system 100 in order to enable designation of an output destination by reading of the code image C is explained. That is, a flow of processing for registering, in the first print service system 100, a dedicated virtual printer for a print job in which an output destination is designated by reading the code image C is explained. FIGS. 8A to 8C are sequence charts illustrating an example of a flow of registration processing for a virtual printer for code executed in the print system 10. The order of processing in steps of the sequence chart is merely an example and can be changed as appropriate as long as no technical contradiction is caused. The flow of the registration processing for the virtual printer for code is explained below with reference to FIGS. 8A to 8C.

In step S100, the administrator performs predetermined operation for starting the registration processing for the virtual printer for code via the input unit 430 of the first terminal device 400. Accordingly, for example, a URL of a virtual printer for code registration page is input to the Web browser 451 of the first terminal device 400. Here, the virtual printer for code registration page is a page prepared for registering the virtual printer for code in the first print service system 100. After step S100, in step S101, the Web browser 451 transmits a request to acquire the virtual printer for code registration page to the relay server 300 according to the input URL. In response to the request, in step S102, the authentication control unit 331 of the relay server 300 instructs the Web browser 451 to access a predetermined redirect page. In this step, the predetermined redirect page is an authentication page. For this reason, the authentication control unit 331 of the relay server 300 transmits a URL of the authentication page to the Web browser 451. The authentication page is a page for requesting the user to input authentication information.

In step S103, the Web browser 451 transmits a request to acquire the authentication page to the first print service system 100 according to the received URL. In response to the request, in step S104, the authentication control unit 131 of the first print service system 100 transmits the authentication page to the Web browser 451. Accordingly, in step S105, the Web browser 451 displays the authentication page on the display unit 420 of the first terminal device 400.

In step S106, the administrator inputs the authentication information to the authentication page via the input unit 430. Specifically, for example, the administrator inputs a user ID of the administrator, a password, and the like. Here, required authentication information is authentication information used in the first print service system 100 and is, specifically, a user ID and a password registered in advance. In step S107, the Web browser 451 transmits the input authentication information to the first print service system 100. The authentication control unit 131 of the first print service system 100 performs authentication processing based on the authentication information received from the Web browser 451. That is, the authentication control unit 131 determines whether the received authentication information coincides with authentication information of the administrator registered in advance.

When the authentication has been successful in the authentication processing, that is, when the received authentication information coincides with the authentication information of the administrator registered in advance, in step S108, the authentication control unit 131 of the first print service system 100 issues an authentication code and further instructs the Web browser 451 to access a predetermined redirect destination. The predetermined redirect destination is the relay server 300. By this redirect, the authentication code is passed to the relay server 300. For that reason, the authentication control unit 131 of the first print service system 100 transmits a URL indicating the predetermined redirect destination to the Web browser 451 together with the authentication code.

In step S109, the Web browser 451 transmits the authentication code to and accesses the predetermined redirect destination. Accordingly, the relay server 300 acquires the authentication code. In step S110, the authentication control unit 331 of the relay server 300 transmits, to the first print service system 100, together with the received authentication code, a request to generate an administrator access token. The administrator access token is information certifying that the access is legitimate access of the administrator, that is, access involving legitimate authority of the administrator. In step S111, after confirming that the authentication code received in step S110 coincides with the authentication code transmitted in step S108, the authentication control unit 131 of the first print service system 100 issues the administrator access token and transmits the administrator access token to the relay server 300. Thereafter, in step S112, the registration unit 332 transmits a virtual printer for code registration page to the Web browser 451. Accordingly, in step S113, the Web browser 451 displays the virtual printer for code registration page on the display unit 420 of the first terminal device 400.

In step S114, the administrator performs, via the input unit 430 of the first terminal device 400, a predetermined operation of requesting registration of the virtual printer for code. In step S114, more specifically, the administrator inputs information for designating a sharer to the virtual printer for code registration page displayed in step S113. The sharer is a user capable of using the virtual printer for code. The information for designating the sharer may be information for designating, as the sharer, a user belonging to a specific group. In this case, the information for designating the sharer may be identification information for specifying a group such as a group ID. Instead of the identification information for specifying the group, a user ID of each of a plurality of users designated as sharers may be input. The information for designating the sharer may be information for designating any user, that is, all users as the sharer.

Subsequently, in step S115, the Web browser 451 transmits, to the relay server 300, together with the information for designating the sharer, a request for requesting registration of the virtual printer for code in the first print service system 100. Accordingly, the registration unit 332 of the relay server 300 acquires a registration instruction for the virtual printer for code from the administrator.

Subsequently, in step S116, the registration unit 332 of the relay server 300 determines a printer name of the virtual printer for code registered in the first print service system 100. The registration unit 332 determines, for example, a predetermined printer name with which the user can identify the virtual printer for code as the printer name of the virtual printer for code registered in the first print service system 100.

Subsequently, in step S117, the registration unit 332 of the relay server 300 requests the first print service system 100 to register the virtual printer for code using the administrator access token acquired in step S111. Specifically, in step S117, the registration unit 332 transmits, to the first print service system 100, together with the administrator access token, a request for requesting creation and registration of the virtual printer for code. At this time, the registration unit 332 transmits, together with the request, the virtual printer name determined in step S116. That is, the registration unit 332 requests setting of the virtual printer name as well together with the registration of the virtual printer.

In response to the request, in step S118, when the authentication control unit 131 has confirmed that the administrator access token received in step S117 is legitimate, the information management unit 133 of the first print service system 100 registers a new virtual printer in the first print service system 100. At this time, the information management unit 133 sets the virtual printer name received in step S117 as a printer name of the virtual printer registered anew. The information management unit 133 determines a virtual printer ID for the new virtual printer as identification information of the new virtual printer and notifies completion of the registration of the virtual printer to the relay server 300f together with the virtual printer ID.

Thereafter, in step S119 to step S122, setting processing for the virtual printer registered anew is performed. Specifically, in step S119, the registration unit 332 of the relay server 300 transmits, to the first print service system 100, together with the administrator access token, a request to set capability information of the virtual printer registered anew. At that time, the registration unit 332 also transmits the virtual printer ID notified in step S118 and the capability information together with the request. The capability information is information indicating capability, as a printer, of the image forming device 600 associated with the virtual printer for code and can also be considered information for specifying a function included in the image forming device 600 serving as a printer. The capability information may be, for example, information indicating whether double-sided printing is possible or may be information indicating whether color printing is possible. As explained above, any image forming device 600 can be associated with the virtual printer for code. For this reason, the registration unit 332 may transmit, as the capability information, only a function common to all the image forming devices 600 that are likely to be associated with the virtual printer for code or may transmit, as the capability information, information indicating that capability is unknown. In response to the request, when the authentication control unit 131 has confirmed that the administrator access token received in step S119 is legitimate, the information management unit 133 of the first print service system 100 performs setting of a virtual printer specified by the received virtual printer ID. More specifically, the information management unit 133 sets the received capability information as the capability information of the virtual printer for code specified by the received virtual printer ID. Accordingly, the created capability information of the virtual printer for code is set.

In step S120, step S121, and step S122, the registration unit 332 of the relay server 300 performs setting concerning shared use of the virtual printer registered anew. That is, in step S120, step S121, and step S122, setting of an access right for the virtual printer for code is performed. Here, since the setting for using the virtual printer for code as the shared printer is performed, specifically, processing explained below is performed. The shared printer is a printer that is assumed to be used by a plurality of users. That is, the shared printer is a printer shared by a plurality of users. When the shared printer, which is the virtual printer for code, is shared by any users, that is, when the relay server 300 has received information for designating any users as sharers in step S115, the registration unit 332 executes processing in step S120 explained below. When the shared printer, which is the virtual printer for code, is set to be shared by users belonging to a specific group, that is, when the relay server 300 has received information for designating the users belonging to the specific group as sharers in step S115, the registration unit 332 executes processing in step S121 and step S122 explained below.

When the relay server 300 has received the information for designating any users as sharers, in step S120, the registration unit 332 performs processing for creating shared information. However, as explained above, here, since it is necessary to allow any users to use the virtual printer for code, shared information for admitting sharing by any users is created. More specifically, in step S120, the registration unit 332 transmits, to the first print service system 100, together with the administrator access token, a request to set shared information of the virtual printer for code registered anew. At that time, the registration unit 332 also transmits, together with the request, the virtual printer ID notified in step S118 and an instruction to designate that sharing by any users is admitted. In the description of step S120 of the sequence chart, a description in which “Yes” is set to a value of a flag indicating sharing with all members (“sharing with all members=Yes”) represents the instruction to designate that sharing with any users is admitted. At this time, the registration unit 332 may also transmit a shared name for identifying shared information created anew to the first print service system 100. For example, the virtual printer name determined in step S116 may be used as such a shared name. The transmission of the shared name may be omitted. In response to the request, when the authentication control unit 131 has confirmed that the administrator access token received in step S120 is legitimate, the information management unit 133 of the first print service system 100 creates, based on the received information, shared information concerning the virtual printer specified by the virtual printer ID. Specifically, the information management unit 133 creates shared information indicating that the sharing with any users is admitted.

When the relay server 300 has received the information for designating users belonging to a specific group as sharers, in step S121, first, the registration unit 332 performs processing for creating shared information. However, since it is necessary to prevent users other than the users belonging to the specific group from using the virtual printer for code, shared information for not admitting sharing with any users is created. More specifically, in step S121, the registration unit 332 transmits, to the first print service system 100, together with the administrator access token, a request to set shared information of a virtual printer registered anew. At that time, the registration unit 332 also transmits, together with the request, the virtual printer ID notified in step S118 and an instruction to designate that sharing with any users is not admitted. In the description of step S121 of the sequence chart, a description in which “No” is set to a value of a flag indicating sharing with all members (“sharing with all members=No”) represents an instruction to designate that sharing with any users is not admitted. At this time, the registration unit 332 may also transmit a shared name for identifying shared information created anew to the first print service system 100. For example, the virtual printer name determined in step S116 may be used as such a shared name. The transmission of the shared name may be omitted. In response to the request, when the authentication control unit 131 has confirmed that the administrator access token received in step S121 is legitimate, the information management unit 133 of the first print service system 100 creates, based on the received information, shared information of the virtual printer specified by the virtual printer ID. Specifically, the information management unit 133 creates shared information indicating that sharing with any users is not admitted.

In step S122, the registration unit 332 performs processing of correcting the shared information such that only users belonging to the specific group can use a registration target printer. Specifically, in step S122, the registration unit 332 transmits, to the first print service system 100, together with the administrator access token, a request to correct the shared information to permit use of the virtual printer by the users belonging to the specific group. At this time, the registration unit 332 transmits, for example, the group ID acquired in step S115 as information for specifying a user for whom sharing is permitted. In response to the request, when the authentication control unit 131 has confirmed that the administrator access token received in step S122 is legitimate, the information management unit 133 of the first print service system 100 updates the shared information based on the received information. Specifically, the information management unit 133 updates the shared information to permit the use by the user specified by the received group ID. In the sequence chart illustrated in FIG. 8C, the setting of the shared information is performed over two steps, i.e., step S121 and step S122. However, these kinds of processing may be performed in one step.

After step S120 or step S122, in step S123, the registration unit 332 of the relay server 300 stores, in the database of the storage unit 310 or the like, the virtual printer ID of the virtual printer registered as the virtual printer for code.

In step S124, the Web browser 451 inquires the relay server 300 whether the registration processing for the virtual printer for code has been completed. In response to the inquiry, in step S125, the registration unit 332 of the relay server 300 transmits, to the Web browser 451, a registration completion page, which is a page indicating that the registration has been completed. Accordingly, in step S126, the Web browser 451 displays the registration completion page on the display unit 420 of the first terminal device 400. In the sequence chart illustrated here, the step of inquiring whether the registration processing for the virtual printer for code has been completed is performed after step S123. However, the step may be periodically performed before step S123. In that case, the registration unit 332 may transmit a page indicating that the registration has not been completed to the Web browser 451.

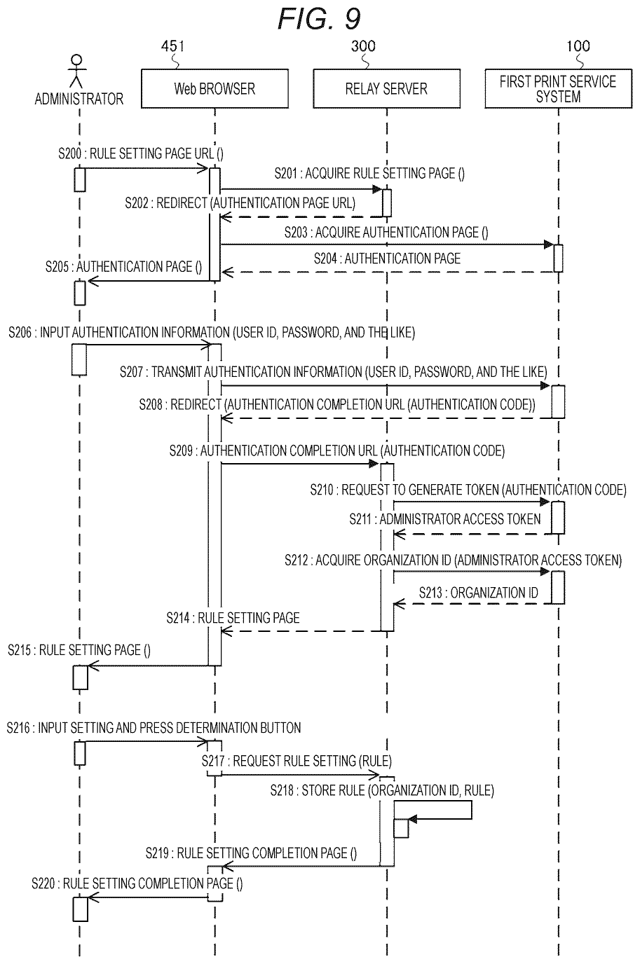

Subsequently, a flow of setting processing for the rule explained above concerning the use of the image forming device 600 is explained. FIG. 9 is a sequence chart illustrating an example of the flow of the setting processing for the rule concerning the use of the image forming device 600. The order of processing in steps of the sequence chart is merely an example and can be changed as appropriate as long as no technical contradiction is caused. The flow of the setting processing for the rule is below with reference to FIG. 9.

In step S200, the administrator performs predetermined operation for starting the setting processing of the rule via the input unit 430 of the first terminal device 400. Accordingly, for example, a URL of a rule setting page is input to the Web browser 451 of the first terminal device 400. Here, the rule setting page is a page prepared for setting a rule concerning the use of the image forming device 600. After step S200, in step S201, the Web browser 451 transmits, according to the input URL, to the relay server 300, a request to acquire the rule setting page. In response to the request, in step S202, the authentication control unit 331 of the relay server 300 instructs the Web browser 451 to access a predetermined redirect page. In this step, the predetermined redirect page is an authentication page. For this reason, the authentication control unit 331 of the relay server 300 transmits a URL of the authentication page to the Web browser 451.

In step S203, the Web browser 451 transmits, according to the received URL, to the first print service system 100, a request to acquire the authentication page. In response to the request, in step S204, the authentication control unit 131 of the first print service system 100 transmits the authentication page to the Web browser 451. Accordingly, in step S205, the Web browser 451 displays the authentication page on the display unit 420 of the first terminal device 400.

In step S206, the administrator inputs authentication information to the authentication page via the input unit 430. Specifically, for example, the administrator inputs a user ID of the administrator, a password, and the like. Here, required authentication information is authentication information used in the first print service system 100 and is, specifically, a user ID and a password registered in advance. In step S207, the Web browser 451 transmits the input authentication information to the first print service system 100. The authentication control unit 131 of the first print service system 100 performs authentication processing based on the authentication information received from the Web browser 451. That is, the authentication control unit 131 determines whether the received authentication information coincides with authentication information of the administrator registered in advance.

When the authentication has been successful in the authentication processing, that is, when the received authentication information coincides with the authentication information of the administrator registered in advance, in step S208, the authentication control unit 131 of the first print service system 100 issues an authentication code and instructs the Web browser 451 to access a predetermined redirect destination. The predetermined redirect destination is the relay server 300. By this redirect, the authentication code is passed to the relay server 300. For that reason, the authentication control unit 131 of the first print service system 100 transmits a URL indicating the predetermined redirect destination to the Web browser 451 together with the authentication code.

In step S209, the Web browser 451 transmits the authentication code and accesses the predetermined redirect destination. Accordingly, the relay server 300 acquires the authentication code. In step S210, the authentication control unit 331 of the relay server 300 transmits, to the first print service system 100, together with the received authentication code, a request to generate an administrator access token. In step S211, after confirming that the authentication code received in step S210 coincides with the authentication code transmitted in step S208, the authentication control unit 131 of the first print service system 100 issues an administrator access token and transmits the administrator access token to the relay server 300.

Subsequently, in step S212, the setting management unit 333 of the relay server 300 transmits, to the first print service system 100, together with the administrator access token acquired in step S211, a request to acquire an organization ID of the administrator. The organization ID of the administrator is identification information of a user organization to which the administrator belongs, in other words, identification information of a user organization managed by the administrator. As explained above, in the present embodiment, a rule applied when any user belonging to a user organization to which the administrator who instructs to generate a rule belongs uses the image forming device 600 is generated. For this reason, it is necessary to correlate the generated rule with the organization ID. Thus, in this step, the setting management unit 333 transmits a request to acquire the organization ID.

In response to the request, in step S213, when the authentication control unit 131 has confirmed that the administrator access token received in step S212 is legitimate, the information management unit 133 of the first print service system 100 transmits the organization ID of the administrator to the relay server 300. Specifically, the information management unit 133 transmits the organization ID to the relay server 300. Accordingly, the setting management unit 333 of the relay server 300 acquires the organization ID of the administrator. Thereafter, in step S214, the setting management unit 333 transmits a rule setting page to the Web browser 451. Accordingly, in step S215, the Web browser 451 displays the rule setting page on the display unit 420 of the first terminal device 400.

The rule setting page is, for example, a page for providing a user interface for setting a rule concerning the use of the image forming device 600. The administrator can set desired rules for the image forming devices 600. As explained above, the administrator may set the rule for using the image forming device 600 in units of device organizations using the rule setting page. The set rule may be a rule concerning whether to permit the use of the image forming device 600 or may be a rule concerning whether to notify a warning when the image forming device 600 is used. Specifically, for example, the administrator sets any one of the rules 1 to 5 described above for the image forming devices 600. In step S216, the administrator performs input for setting a rule to the rule setting page via the input unit 430 and presses a determination button displayed on the rule setting page. In step S217, the Web browser 451 transmits setting information of the input rule to the relay server 300 and requests the relay server 300 to set the rule. In response to the request, in step S218, the setting management unit 333 of the relay server 300 generates a rule conforming to the setting information and stores the rule in the storage unit 310 in correlation with the organization ID acquired in step S213.

Thereafter, in step S219, the setting management unit 333 transmits a rule setting completion page to the Web browser 451. The rule setting completion page is a page for notifying that the rule is appropriately stored in the relay server 300. Accordingly, in step S220, the Web browser 451 displays the rule setting completion page on the display unit 420 of the first terminal device 400.

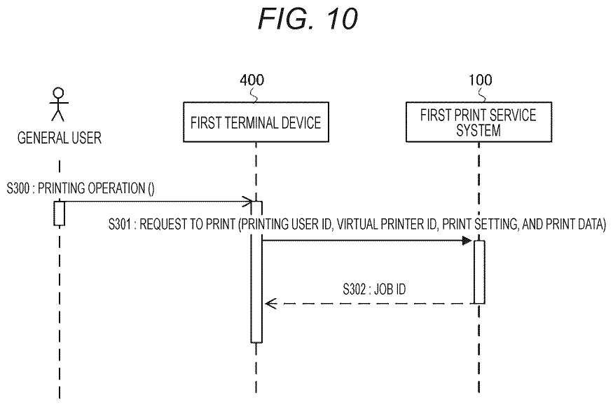

Subsequently, a flow of processing in which the print system 10 receives print target data is explained. In the following explanation, the print target data is referred to as print data. FIG. 10 is a sequence chart illustrating an example of the flow of the processing in which the print system 10 receives print data. The flow of the processing is explained with reference to FIG. 10.

In step S300, a general user belonging to a user organization performs, via the input unit 430 of the first terminal device 400, predetermined operation for printing print data. Specifically, for example, the general user performs operation for designating a virtual printer to be used for the printing, print data, and a print setting. In the present embodiment, the user designates, using the code image C attached to the image forming device 600, the image forming device 600 used for printing. Therefore, in this step, the user designates a virtual printer for code as the virtual printer to be used for the printing. The print setting designated in step S300 is a setting value set in the printer for printing. Examples of the print setting include, but are not limited to, a setting value for designating a size of paper to be used, a setting value for designating whether to perform color printing, and a setting value for designating whether to perform double-sided printing. At a stage of designating the print setting in step S300, the image forming device 600 to be actually used for the printing is not determined among the plurality of image forming devices 600 connected to the second print service system 200. Therefore, the print setting designated in step S300 is limited to a print setting common to the plurality of image forming devices 600 connected to the second print service system 200.

When the operation in step S300 is performed, in step S301, the print request unit 452 of the first terminal device 400 requests the first print service system 100 to perform printing. At this time, the print request unit 452 transmits, to the first print service system 100, a user ID of the user who has instructed the printing in step S300, a virtual printer ID of the virtual printer for code, the designated print setting, and the designated print data. Then, the first print service system 100 acquires the user ID, the virtual printer ID, the designated print setting, and the designated print data. The print control unit 132 of the first print service system 100 receives, concerning a request for printing using the virtual printer for code, only requests of users who are sharers of the virtual printer for code and does not receive requests of the other users.

Subsequently, in step S302, the print control unit 132 of the first print service system 100 generates a print job based on the information received in step S301 and notifies, to the first terminal device 400, a job ID that is identification information of the print job. The generated print job remains accumulated in the first print service system 100 until the user instructs printing after determining the image forming device 600 at an output destination using the code image C. At that time, the print job is accumulated in the first print service system 100 in a state of being correlated with the virtual printer ID of the virtual printer for code and the user ID.

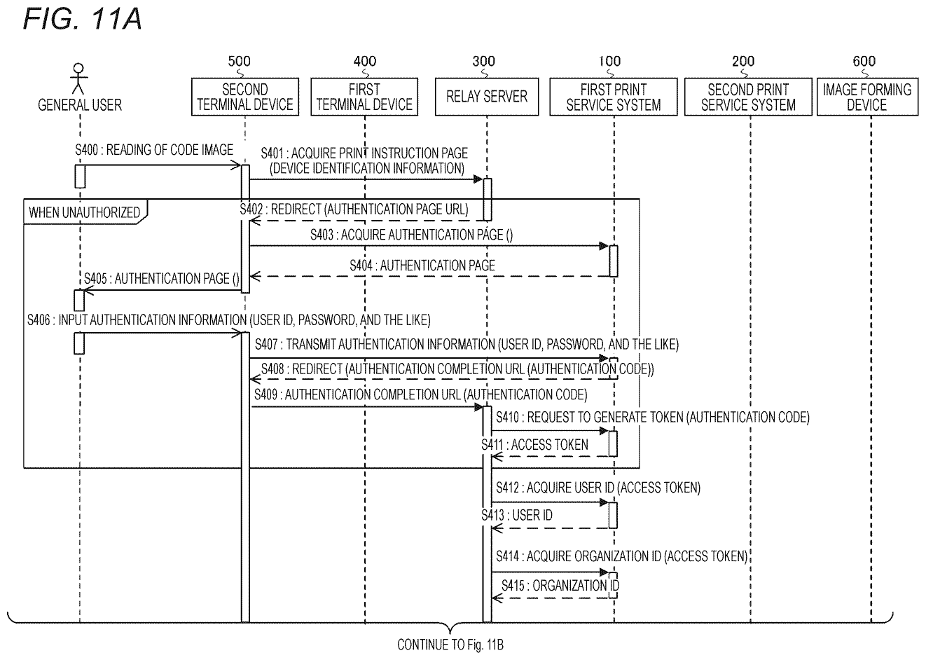

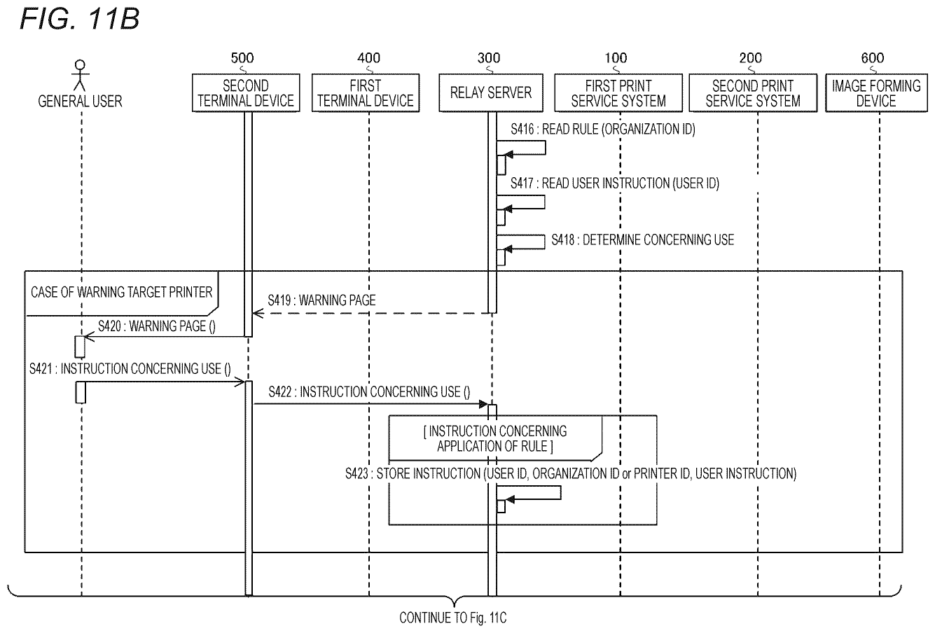

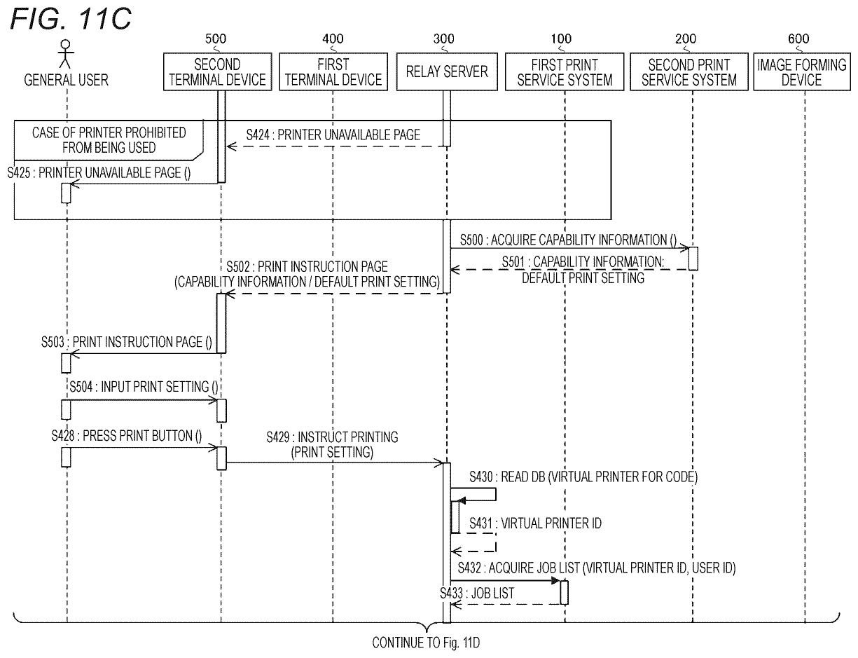

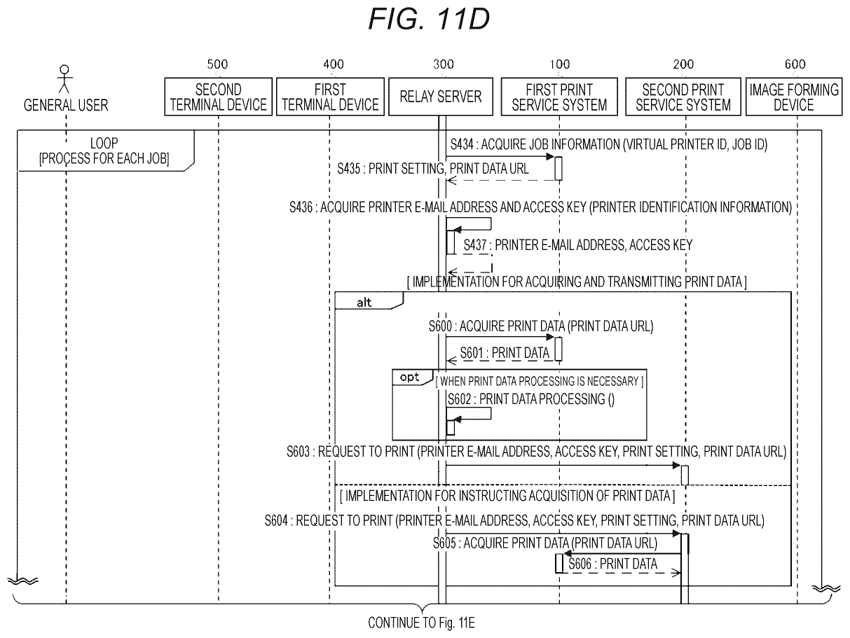

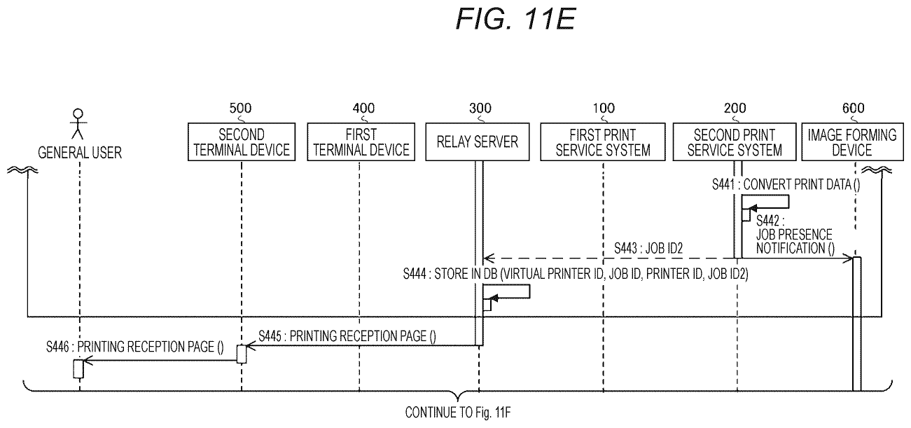

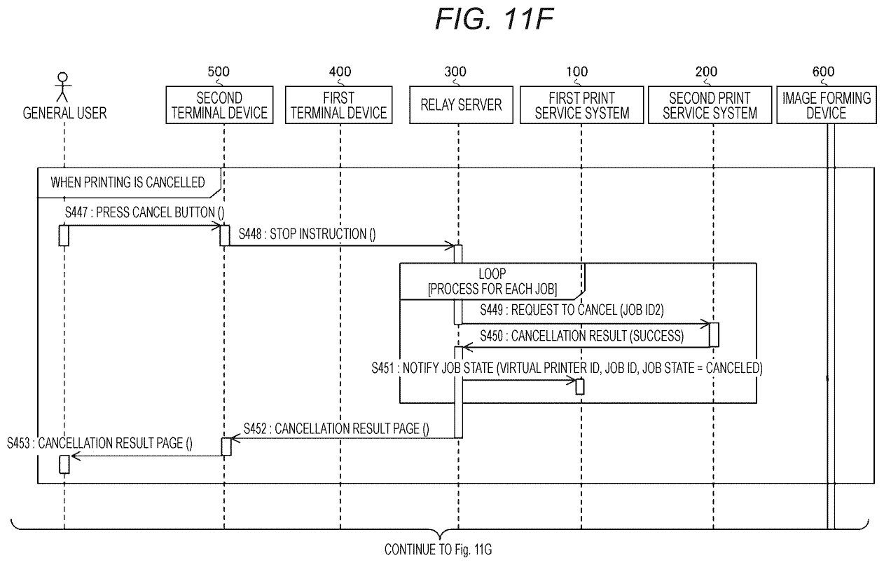

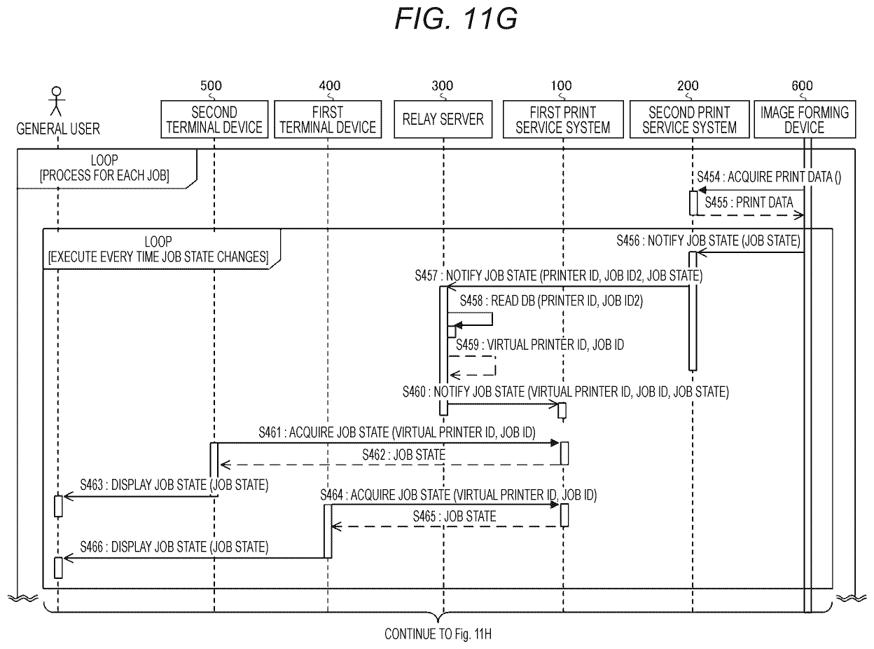

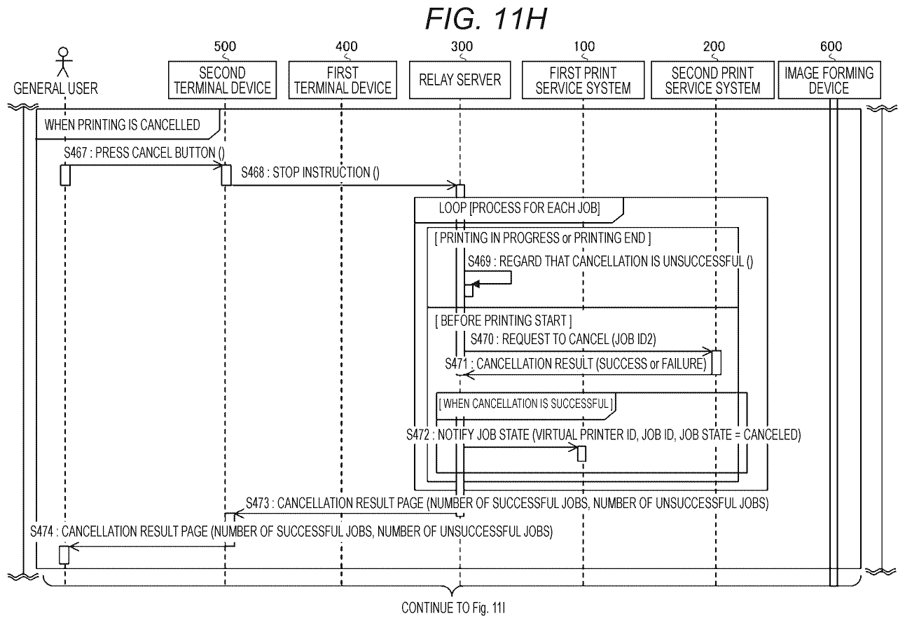

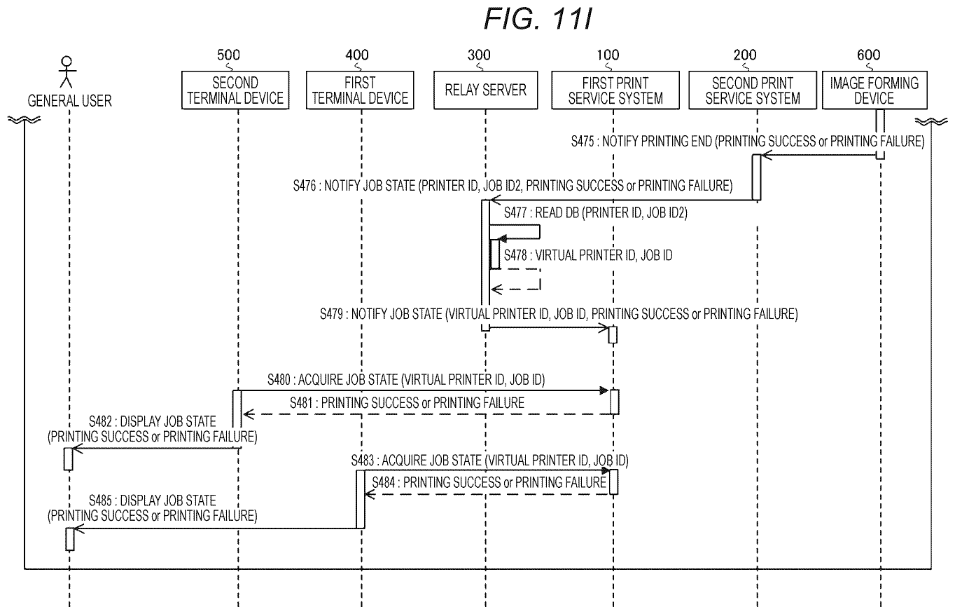

Subsequently, a flow of print processing in the case in which the user performs printing in the image forming device 600 specified by the code image C read by the second terminal device 500 is explained. FIGS. 11A to 11I are sequence charts illustrating an example of the flow of the print processing executed by the print system 10. The order of processing in steps of the sequence chart is merely an example and can be changed as appropriate as long as no technical contradiction is caused. In the following explanation, the flow of the print processing is explained with reference to FIGS. 11A to 11I. Further, for example, in FIGS. 11C and 11D, steps in the 400s, steps in the 500s, and steps in the 600s are mixed. However, these step numbers are merely used for convenience of explanation and do not specifically indicate execution order of processing.

The general user who has performed in the operation in step S300 in FIG. 10 moves to the image forming device 600 from which the general user desires to acquire a print. In step S400, the general user performs, using the reading unit 550 of the second terminal device 500, operation for reading the code image C attached to the image forming device 600 from which the general user desires to acquire a print. The code image C includes device identification information, which is identification information of the image forming device 600, and a URL for accessing the relay server 300.

After step S400, in step S401, the Web browser 561 transmits, to the relay server 300, according to the URL obtained from the code image C, a request to acquire a print instruction page. Here, the print instruction page is a page prepared for a user to instruct the relay server 300 to execute printing. At this time, the Web browser 561 transmits, to the relay server 300, together with the request to acquire the print instruction page, the device identification information included in the code image C read by the reading unit 550. That is, in the present embodiment, the identification information transmission unit 562 implemented as the Web browser 561 transmits the device identification information to the relay server 300. Accordingly, the device identification information acquisition unit 334 of the relay server 300 acquires device identification information for specifying the image forming device 600 used for the printing.

In the present embodiment, as explained above, authentication printing is performed in the print system 10. For this reason, in step S402 to step S411, user authentication using the authentication function of the first print service system 100 is performed. When the authentication by the first print service system 100 has already been normally completed for the user who performs the operation in step S400, processing in step S402 to step S411 may be omitted.

In step S402, the authentication control unit 331 of the relay server 300 instructs the Web browser 561 to access a predetermined redirect page. In this step, the predetermined redirect page is an authentication page. For this reason, the authentication control unit 331 of the relay server 300 transmits a URL of the authentication page to the Web browser 561 of the second terminal device 500. As it is seen from step S401 and step S402, the authentication control unit 331 notifies, according to access from the second terminal device 500 based on the code image C read by the second terminal device 500, to the second terminal device 500, an access destination for transmitting authentication information to the first print service system 100. Accordingly, the second terminal device 500 can automatically obtain an access destination for authentication.

In step S403, the Web browser 561 of the second terminal device 500 transmits, according to the received URL, to the first print service system 100, a request to acquire an authentication page. In response to the request, in step S404, the authentication control unit 131 of the first print service system 100 transmits the authentication page to the Web browser 561. Accordingly, in step S405, the Web browser 561 displays the authentication page on the display unit 520 of the second terminal device 500.

In step S406, the user who has performed the operation in step S400 inputs the authentication information to the authentication page via the input unit 530. Specifically, for example, the user inputs a user ID of the user, a password, and the like. Here, required authentication information is authentication information used in the first print service system 100 and is, specifically, a user ID and a password registered in advance. In step S407, the Web browser 561 transmits the input authentication information to the first print service system 100. The authentication control unit 131 of the first print service system 100 performs authentication processing based on the authentication information received from the Web browser 561 of the second terminal device 500. That is, the authentication control unit 131 determines whether the received authentication information coincides with authentication information of the administrator registered in advance.

When the authentication has been successful in the authentication processing, that is, when the received authentication information coincides with the authentication information of the user registered in advance, in step S408, the authentication control unit 131 of the first print service system 100 issues an authentication code and instructs the Web browser 561 to access a predetermined redirect destination. The predetermined redirect destination is the relay server 300. By this redirect, the authentication code is passed to the relay server 300. For that reason, the authentication control unit 131 of the first print service system 100 transmits a URL indicating the predetermined redirect destination to the Web browser 561 of the second terminal device 500 together with the authentication code.

In step S409, the Web browser 561 of the second terminal device 500 transmits the authentication code and accesses the predetermined redirect destination. Accordingly, the relay server 300 acquires the authentication code. In step S410, the authentication control unit 331 of the relay server 300 transmits, to the first print service system 100, together with the received authentication code, a request to generate an access token. The access token is information for certifying that the access is legitimate access by the user of the first print service system 100, that is, access involving legitimate authority of the user and is equivalent to authentication completion information. That is, the access token indicates that the authentication by the first print service system 100 for the authentication information of the user is completed. In step S411, after confirming that the authentication code received in step S410 coincides with the authentication code transmitted in step S408, the authentication control unit 131 of the first print service system 100 issues an access token and transmits the access token to the relay server 300. Accordingly, the authentication control unit 331 of the relay server 300 acquires the access token, that is, the authentication completion information. When the authentication completion information is not obtained, the relay server 300 ends the processing without executing subsequent processing.

Subsequently, in step S412, the print control unit 335 of the relay server 300 transmits, to the first print service system 100, together with the access token acquired in step S411, a request to acquire a user ID of the user who has performed the operation in step S400. In response to the request, in step S413, when the authentication control unit 131 has confirmed that the access token received in step S412 is legitimate, the information management unit 133 of the first print service system 100 transmits the user ID to the relay server 300. Specifically, the information management unit 133 transmits the user ID managed by the first print service system 100 to the relay server 300. Accordingly, the print control unit 335 of the relay server 300 acquires the user ID of the user who has performed the operation in step S400.

Subsequently, in step S414, the print control unit 335 of the relay server 300 transmits, to the first print service system 100, together with the access token acquired in step S411, a request to acquire an organization ID of the user who has performed the operation in step S400. The organization ID of the user is identification information of a user organization to which the user belongs. As explained above, in the present embodiment, the rules are set for each user organization. For this reason, it is necessary to acquire the organization ID of the user in order to specify a rule that should be applied to the user. In response to the request, in step S415, when the authentication control unit 131 has confirmed that the access token received in step S414 is legitimate, the information management unit 133 of the first print service system 100 transmits the organization ID of the user to the relay server 300. Specifically, the information management unit 133 transmits the organization ID to the relay server 300. Accordingly, the print control unit 335 of the relay server 300 acquires the organization ID of the user. As explained above, the print control unit 335 acquires the organization information (the organization ID) of the user organization to which the user belongs from the first print service system 100 and determines, based on the acquired organization information, the rule applied to the user. For this reason, even when various organizations use the print system 10, rules can be appropriately applied. The print control unit 335 uses the access token equivalent to the authentication completion information in order to acquire the organization information (the organization ID) of the user organization from the first print service system 100. Therefore, when the authentication of the user has not been normally completed, the print control unit 335 interrupts the processing. For this reason, unauthorized use of the system can be prevented.

Subsequently, in step S416, the print control unit 335 reads a rule stored in advance. Specifically, the print control unit 335 reads a rule correlated with the organization ID acquired in step S415 among the rules stored in the storage unit 310. In step S417, when an instruction concerning the application of the rule is stored, the print control unit 335 reads the instruction. Specifically, the print control unit 335 reads an instruction correlated with the user ID acquired in step S413 among the instructions stored in the storage unit 310. When an instruction correlated with the user ID acquired in step S413 is not stored yet, an instruction is not read in this step.

In step S418, the print control unit 335 refers to the read rule and the read instruction and performs, based on the read and the instruction, determination concerning the use of the image forming device 600 identified by the device identification information acquired in step S401. When the image forming device 600 identified by the device identification information acquired in step S401 is a printer permitted to be used without involving a warning, the print control unit 335 associates the image forming device 600 identified by the device identification information acquired in step S401 and the virtual printer for code with each other and immediately executes processing in step S426 and subsequent steps. In contrast, when the image forming device 600 identified by the device identification information acquired in step S401 is a printer for which a notification of a warning is necessary, processing in step S419 to step S423 is executed. When the image forming device 600 identified by the device identification information acquired in step S401 is a printer prohibited from being used, processing in step S424 and step S425 is executed.

First, a flow of processing in the case in which the image forming device 600 identified by the device identification information acquired in step S401 is a printer for which a notification of a warning is necessary is explained. In step S419, the print control unit 335 of the relay server 300 transmits a warning page to the Web browser 561. Accordingly, in step S420, the Web browser 561 displays an authentication page on the display unit 520 of the second terminal device 500. The warning page is a page for warning of the use of the image forming device 600 identified by the device identification information acquired in step S401. Therefore, in the sequence chart illustrated here, in step S419, notification of a warning based on the rule is performed. The warning page may also be a page for providing a user interface for inputting an instruction of the user for the warning. For example, a button for instructing whether to use or reject the image forming device 600 may be arranged on the warning page. For example, a button for selecting, when the use is rejected, whether to reject the use only this time or to reject the use the next and subsequent times may be arranged on the warning page. For example, a button for instructing to omit a warning for the use of the image forming device 600 in the future may be arranged on the warning page. A button that can select all the image forming devices 600 managed by a specific organization as a use rejection target or a warning omission target may be arranged. Since the warning can be omitted only when a rule for enabling the omission of the warning is set in the image forming device 600, the print control unit 335 creates a warning page corresponding to the rule referred to in step S416 and transmits the warning page to the second terminal device 500.

In step S421, after checking the warning page, the user inputs an instruction concerning the use of the image forming device 600. The user at least inputs an instruction to use or reject the image forming device 600 as the warning target. The user inputs an instruction concerning the application of the rule such as an instruction to omit a warning according to necessity. For example, the user inputs the instruction by operating a button arranged on the warning page. However, the input may be performed by other methods.

Subsequently, in step S422, the Web browser 561 transmits the instruction of the user input in step S421 to the relay server 300. That is, in the present embodiment, the instruction transmission unit 563 implemented as the Web browser 561 transmits the instruction of the user to the relay server 300. Accordingly, the relay server 300 receives the instruction.

When the instruction received in step S422 includes the instruction concerning the application of the rule, in step S423, the setting management unit 333 stores the instruction in the storage unit 310. Specifically, for example, when an instruction to omit a warning and an instruction to reject continuous use are received in step S422, the setting management unit 333 stores the instructions in the storage unit 310 in correlation with the user ID acquired in step S413. When an instruction target is only one image forming device 600, the print control unit 335 stores device identification information (a printer ID) of the image forming device 600 and the instructions in the storage unit 310 in correlation with each other. When the instruction target is all the image forming devices 600 of a specific organization, the print control unit 335 stores an organization ID of the organization and the instructions in the storage unit 310 in correlation with each other.

When the instruction received by the relay server 300 in step S422 is an instruction to use the image forming device 600 set as a warning target, the print control unit 335 associates the image forming device 600 and the virtual printer for code with each other. The processing proceeds to step S426. In contrast, when the instruction received by the relay server 300 in step S422 is an instruction not to use the image forming device 600 set as the warning target, the processing ends. In this case, the user moves to another image forming device 600 and performs the processing in step S400 again.

Subsequently, a flow of processing performed when the image forming device 600 identified by the device identification information acquired in step S401 is a printer prohibited from being used is explained. In this case, in step S424, the print control unit 335 of the relay server 300 transmits a printer unavailable page to the Web browser 561. Accordingly, in step S425, the Web browser 561 displays the printer unavailable page on the display unit 520 of the second terminal device 500. The printer unavailable page is a page for notifying that the use of the image forming device 600 identified by the device identification information acquired in step S401 is prohibited. When the use of the image forming device 600 is prohibited by a rule corresponding to the image forming device 600 identified by the device identification information acquired in step S401 or an instruction of the user, the processing in step S424 and step S425 is performed. In this case, the user moves to another image forming device 600 and performs the processing in step S400 again.

In step S500, the capability information control unit 336 of the relay server 300 transmits, to the second print service system 200, a request to acquire capability information of the image forming device 600 selected using the second terminal device 500. As explained above, the capability information is information indicating capability as a printer of the image forming device 600 designated by the user and can also be considered information for specifying various functions included the image forming device 600 serving as the printer. The various functions can include, in addition to the function of changing a size of paper to be used, the function of switching between color printing and monochrome printing, and the function of performing double-sided printing, for example, a function of switching a type of printing paper, a function of changing print quality, a function of inserting a stamp in a print, a function of binding prints with a stapler, a function of changing a binding position when binding the prints with the stapler, a function of forming a punch hole in a print, and a function of changing a forming position when forming the punch hole in the print. In response to the request, in step S501, the print control unit 231 of the second print service system 200 transmits the capability information of the image forming device 600 designated by the user to the relay server 300. Specifically, the print control unit 231 transmits a default print setting corresponding to the capability information to the relay server 300 together with the capability information of the image forming device 600 designated by the user. The default print setting indicates a default setting value that is a standard setting value for each item of a print setting indicated by the capability information.

In step S502, the capability information control unit 336 of the relay server 300 transmits a print instruction page to the Web browser 561. Specifically, the print control unit 335 transmits the print instruction page to the Web browser 561 together with the capability information and the default print setting. Accordingly, in step S503, the Web browser 561 displays the print instruction page on the display unit 520 of the second terminal device 500. The print instruction page is a page for receiving a print instruction from the user. For example, a print button, which is a button for the user to instruct the print system 10 to execute printing, is arranged on the print instruction page. The print instruction page is a page for receiving designation of a print setting corresponding to the image forming device 600 designated by the user. A print setting that can be designated in the print instruction page displayed in step S503 corresponds to the capability information. The number of items of the print setting that can be designated in the print instruction page displayed in step S503 typically coincides with the number of items of functions specified by the capability information. Therefore, the print setting that can be designated in the print instruction page displayed in step S503 can include, for example, a setting value for designating a type of paper to be used in addition to the setting value for designating a size of paper to be used, the setting value for designating whether to perform color printing, and the setting value for designating whether to perform duplex printing. When the image forming device 600 designated by the user can select expensive and high-quality paper and inexpensive and low-quality paper as the paper to be used for printing, the designating a type of paper to be used means selecting the expensive and high-quality paper or the inexpensive and low-quality paper. The print setting that can be designated in the print instruction page displayed in step S503 may further include a setting value for designating print quality, a setting value for designating whether to insert a stamp in a print, a setting value for designating whether to bind prints with a stapler, a setting value for designating a binding position when the prints are bound by the stapler, a setting value for designating whether to form a punch hole in a print, and a setting value for designating a formation position when the punch hole is formed in the print. The number of items of the print setting that can be designated in the print instruction page displayed in step S503 may not coincide with the number of items of the function specified by the capability information. That is, the number of items of the print setting that can be designated in the print instruction page displayed in step S503 may be smaller than the number of items of the functions specified by the capability information. In step S502, the capability information control unit 336 of the relay server 300 may directly transmit the capability information received from the second print service system 200 in step S501 to the Web browser 561 without processing the capability information or may transmit the capability information received from the second print service system 200 in step S501 after processing the capability information. Here, the processing the capability information typically means deleting at least one of a plurality of functions of the image forming device 600 indicated by the capability information.

The Web browser 561 displays, based on the capability information acquired in step S502, for each item, print settings that can be designated by the user. At that time, the Web browser 561 may display default setting values for each item based on the default print setting acquired in step S502. In step S504, the user inputs, via the input unit 530 of the second terminal device 500, a print setting corresponding to the image forming device 600 designated by the user. That is, the user inputs or changes, via the input unit 530 of the second terminal device 500, setting values for each item of a print setting that can be handled by the image forming device 600 designated by the user. In the print instruction page displayed in step S503, a check box for instructing not to change a setting is arranged for each item. Therefore, instead of inputting or changing the setting value for each item of the print setting that can be handled by the image forming device 600 designated by the user via the input unit 530 of the second terminal device 500, the user may input, for several items, a check mark in the check box for instructing not to change a setting. As explained above, in step S504, the user U is enabled to freely select whether to change or not to change a setting for each item. Therefore, for example, when printing of a print job in which sizes of print paper are set to be different from one another for each page is executed, it is possible to execute printing with a paper size set for each page.

Here, the difference between the print setting designated in step S300 and the print setting designated in step S504 is explained. In step S300, the image forming device 600 actually used for printing by the user is not determined. Therefore, as explained above, the print setting that can be designated in step S300 is limited to print settings that can be handled by most of the image forming devices 600 such as the setting value for designating a size of paper to be used, the setting value for designating whether to perform color printing, and the setting value for designating whether to perform duplex printing. In contrast, in step S504, the image forming device 600 actually used for printing by the user has already been designated. Therefore, the print setting that can be designated in step S504 can include a more detailed print setting that can be handled by the image forming device 600 designated by the user.

In step S428, the user presses the print button displayed on the print instruction page. In step S429, the Web browser 561 transmits an instruction to execute printing to the relay server 300. Specifically, the Web browser 561 transmits a print instruction to the relay server 300 together with the print setting input in step S504. That is, in the present embodiment, the instruction transmission unit 563 implemented as the Web browser 561 transmits the instruction to execute printing. Accordingly, the print control unit 335 of the relay server 300 receives the instruction to execute printing together with the print setting.

When the relay server 300 receives the instruction to execute printing, in step S430, the print control unit 335 of the relay server 300 performs reading processing for a database of the storage unit 310 or the like in order to acquire a virtual printer ID of the virtual printer for code. Accordingly, in step S431, the print control unit 335 reads the virtual printer ID of the virtual printer for code.

Subsequently, in step S432, the print control unit 335 of the relay server 300 acquires a list of print jobs for print data that should be printed by the image forming device 600 identified by the device identification information included in the code image C. Specifically, the print control unit 335 transmits a request to acquire the job list to the first print service system 100. More specifically, the print control unit 335 transmits the request together with the virtual printer ID acquired in step S431 and the user ID acquired in step S413. In response to the request, in step S433, the print control unit 132 of the first print service system 100 transmits, to the relay server 300, a list of print jobs accumulated in the first print service system 100. That is, the print control unit 132 of the first print service system 100 transmits a job list concerning print jobs correlated with the virtual printer for code and also correlated with the received user ID. When the job list is transmitted from the first print service system 100, processing in step S434 to step S444 is performed for each print job listed in the job list.

In step S434, the print control unit 335 of the relay server 300 transmits a request to acquire job information to the first print service system 100. Specifically, the print control unit 335 transmits the request together with the virtual printer ID notified in step S431 and a job ID listed in the job list acquired in step S433. In response to the request, in step S435, the print control unit 132 of the first print service system 100 transmits, to the relay server 300, as job information, a print setting corresponding to the job ID and a URL indicating a storage location of print data corresponding to the job ID. Here, for an item for which a setting value is not changed in the print setting received from the second terminal device 500 in step S429, in the subsequent processing, the relay server 300 follows the print setting received from the first print service system 100 in step S435. Alternatively, for the item for which the setting value is not changed in the print setting received from the second terminal device 500 in step S429, in the subsequent processing, for each item, the relay server 300 may adopt a print setting obtained by applying the print setting received from the first print service system 100 in step S435 to the default print setting received from the second print service system 200 in step S501. On the other hand, for an item not indicating that a setting value is not changed in the print setting received from the second terminal device 500 in step S429, that is, an item for which a check mark is not input to the check box, in the subsequent processing, the relay server 300 follows the print setting received from the second terminal device 500 in step S429. In the following explanation, the URL indicating the storage location of the print data is referred to as print data URL.

When the relay server 300 receives the job information, in step S436, the print control unit 335 of the relay server 300 performs reading processing for the database of the storage unit 310 or the like in order to acquire information required for access to the image forming device 600 identified by the device identification information included in the code image C. Accordingly, in step S437, the print control unit 335 reads the information required for access. In the present embodiment, specifically, the information required to access the image forming device 600 is an e-mail address allocated in advance to the image forming device 600 identified by the device identification information included in the code image C and an access key such as a password. These kinds of information are stored in advance in the database of the storage unit 310 or the like of the relay server 300. When these kinds of information are unnecessary for access to the image forming device 600, step S436 and step S437 may be omitted.

Subsequently, a first implementation mode in which the relay server 300 acquires print data from the first print service system 100 and transmits the acquired print data to the second print service system 200 and a second implementation mode in which the relay server 300 instructs the second print service system 200 to acquire print data from the first print service system 100 are explained. The relay server 300 may implement only one of the first implementation mode and the second implementation mode or may implement the first implementation mode and the second implementation mode in a selectable manner. In the first implementation mode, steps S600 to S603 are executed. In contrast, in the second implementation mode, steps S604 to S606 are executed.

### First Implementation Mode

In step S600, the print control unit 335 of the relay server 300 accesses the print data URL notified in step S435 in order to acquire print data. Accordingly, in step S601, the print control unit 335 of the relay server 300 acquires print data from the first print service system 100.

When it is determined in step S602 that it is necessary to process the print data acquired in step S601 by referring to the print setting of the print job, the print control unit 335 processes the print data based on the print setting of the print job. Here, the processing of the print data means, as an example, when a print image indicated by the print data is a color image, processing the print data such that the print image becomes a monochrome image. Even when the print data needs to be processed, instead of the print control unit 335, the print control unit 231 of the second print service system 200 may carry out the processing of the print data or the image forming device 600 may carry out the processing of the print data. As the processing for which an implementation entity does not matter, typically, there is simple processing of only changing the print image indicated by the print data from a color image to a monochrome image. In this case, step 602 is omitted. Note that step S602 is also omitted when the print data acquired in step S601 according to the print setting does not need to be processed.

Subsequently, in step S603, the print control unit 335 of the relay server 300 requests the second print service system 200 to perform printing. At that time, the print control unit 335 transmits the printer e-mail address and the access key read in step S437, the print setting acquired in step S429, the print setting acquired in step S435, the print setting changed from the default print setting acquired in step S501, and the print data to the second print service system 200. As explained above, the print control unit 335 requests the second print service system 200 to perform printing by the image forming device 600 identified by the device identification information included in the code image C.

When the print setting is changed from the print setting acquired in step S429, the print setting acquired in step S435, and the default print setting acquired in step S501, for each item, the print setting acquired in step S429 is most preferentially adopted and, then, the print setting acquired in step S435 is preferentially adopted. However, alternatively, when the print setting is changed from the print setting acquired in step S429, the print setting acquired in step S435, and the default print setting acquired in step S501, for each item, the print setting acquired in step S435 may be most preferentially adopted and, then, the print setting acquired in step S429 may be preferentially adopted. The same applies to step S604 explained below.

### Second Implementation Mode

In step S604, the print control unit 335 of the relay server 300 requests the second print service system 200 to perform printing. At that time, the print control unit 335 transmits the printer e-mail address and the access key read in step S437, the print setting acquired in step S429, the print setting acquired in step S435, the print setting changed from the default print setting acquired in step S501, and the print data URL acquired in step S435 to the second print service system 200. As explained above, the print control unit 335 requests the second print service system 200 to perform printing by the image forming device 600 identified by the device identification information included in the code image C.

In step S605, the print control unit 231 of the second print service system 200 accesses the print data URL notified in step S605 in order to acquire print data. Accordingly, in step S606, the print control unit 231 of the second print service system 200 acquires print data from the first print service system 100.

As explained above, when acquiring the print instruction from the second terminal device 500, the print control unit 335 acquires the print job from the first print service system 100 and transmits, to the second print service system 200, a request to cause the image forming device 600 to execute printing for the print job. Accordingly, in the system in which the first print service system 100 and the second print service system 200 cooperate with each other, printing by the image forming device 600 can be executed. In the flow of the processing explained above, the user gives the print instruction collectively for one or more print jobs. However, the user may give the print instruction individually for the print jobs. In this case, the print control unit 335 acquires a list of print jobs from the first print service system 100, transmits the list to the second terminal device 500, acquires, from the second terminal device 500, a print instruction for a print job selected out of the list, and acquires the selected print job from the first print service system 100. With such a configuration, the user can select whether to perform printing for each print job. Therefore, the convenience of the user is improved.

Here, processing for the relay server 300 to acquire a print job from the first print service system 100 is further explained. In the above explanation, in step S432 to step S435, the processing for the relay server 300 to acquire a print job from the first print service system 100 is performed. An access token may be required when these kinds of processing are performed. That is, in step S432, the print control unit 335 of the relay server 300 may transmit a request to acquire a job list to the first print service system 100 together with the access token acquired in step S411. In step S433, when the authentication control unit 131 has confirmed that the received access token is legitimate, the print control unit 132 of the first print service system 100 may transmit a job list to the relay server 300. Similarly, in step S434, the print control unit 335 of the relay server 300 may transmit a request to acquire job information to the first print service system 100 together with the access token acquired in step S411. In step S435, when the authentication control unit 131 has confirmed that the received access token is legitimate, the print control unit 132 of the first print service system 100 may transmit job information to the relay server 300. As explained above, the print control unit 335 may acquire the print job for the user from the first print service system 100 using the access token equivalent to the authentication completion information and transmit, to the second print service system 200, the request to cause the image forming device 600 to execute the printing for the print job. As explained above, when the authentication completion information is required to acquire the print job, the print control unit 335 interrupts the processing in a case in which the authentication of the user is not normally completed. For this reason, unauthorized use of the system can be prevented. It can be interpreted that, even when the access token is not required in the processing in step S432 to step S435, in the present embodiment, the print control unit 335 acquires the print job for the user from the first print service system 100 using the authentication completion information. This is because the user ID (see step S412 and step S413), which is information acquired only when it is confirmed that the access token is legitimate, in step S432 and step S433.

When the first implementation mode is adopted, after step S603 and, when the second implementation mode is adopted, after step S606, in step S441, the print control unit 231 converts the print data acquired in step S603 or step S606 into print data conforming to a predetermined printer language. Thereafter, in step S442, the print control unit 231 notifies, to the image forming device 600 that is a printer used for printing, presence of a print job for printing the converted print data. The print job is a print job corresponding to the print job managed by the first print service system 100 and is a print job managed by the print control unit 231 of the second print service system 200. For this reason, a new ID is assigned separately from the value of the job ID explained above. In the following explanation, the ID of the print job managed by the print control unit 231 of the second print service system 200 is referred to as job ID2. In step S443, the print control unit 231 of the second print service system 200 notifies the job ID2 to the relay server 300. In response to the notification, in step S444, the print control unit 335 of the relay server 300 performs storage processing for a correspondence relationship between the print job of the first print service system 100 and the print job of the second print service system 200. Specifically, the print control unit 335 stores the virtual printer ID, the job ID of the first print service system 100, the device identification information (the printer ID) of the image forming device 600 used for printing, and the job ID of the second print service system 200, that is, the job ID2 in the database of the storage unit 310 or the like in correlation with one another.

When the processing in step S434 to step S444 is performed for all the print jobs listed in the job list acquired in step S433, the processing shifts to step S445. In step S445, the print control unit 335 of the relay server 300 transmits a printing reception page to the Web browser 561. Accordingly, in step S446, the Web browser 561 displays the printing reception page on the display unit 520 of the second terminal device 500. The printing reception page is a page for notifying that the print instruction from the user has been normally received. The printing reception page is also a page for receiving a printing stop instruction from the user. For this reason, a cancel button, which is a button for the user to instruct the print system 10 to stop printing, is arranged on the printing reception page. The user can press the cancel button displayed on the printing reception page according to necessity. In the following explanation, processing (step S447 to step S453) executed in the print system 10 when the cancel button has been pressed by the user before processing in step S454 and subsequent steps explained below is started is explained.

In step S447, the user who desires to stop the printing presses the cancel button displayed on the printing reception page. In step S448, the Web browser 561 transmits a printing stop instruction to the relay server 300. That is, in the present embodiment, the instruction transmission unit 563 implemented as the Web browser 561 transmits the printing stop instruction. Accordingly, the relay server 300 receives the printing stop instruction.

When the relay server 300 receives the printing stop instruction, the processing in step S449 to step S451 is performed for each print job. In step S449, the print control unit 335 of the relay server 300 designates a print job with the job ID2 and requests the second print service system 200 to cancel the processing of the print job. At this point in time, since print processing by the image forming device 600 has not been started yet, the print control unit 231 of the second print service system 200 cancels the print job in step S450. Then, the print control unit 231 transmits, to the relay server 300, a cancellation result indicating that the cancellation has been successful. When the relay server 300 receives the cancellation result from the second print service system 200, in step S451, the print control unit 335 of the relay server 300 notifies a job state to the first print service system 100 together with the virtual printer ID of the virtual printer for code and a job ID as a cancellation target. Specifically, the print control unit 335 notifies, to the first print service system 100, a job state indicating a state in which the cancellation has been performed. As explained above, when the print control unit 335 acquires the cancellation result (that is, the job state) from the second print service system 200, the print control unit 335 transmits the job state to the first print service system 100.

When the processing in step S449 to step S451 has been performed for all the print jobs of cancellation targets, the processing proceeds to step S452. In step S452, the print control unit 335 of the relay server 300 transmits a cancellation result page to the Web browser 561. Accordingly, in step S453, the Web browser 561 displays the cancellation result page on the display unit 520 of the second terminal device 500. The cancellation result page is a page for notifying whether the processing for the print job has been cancelled in response to the printing stop instruction from the user. That is, the cancellation result page is a page for notifying whether the printing is normally stopped. At a point in time when the print processing by the image forming device 600 is not started, since the printing stop is successful, the cancellation result page indicating that the printing stop has been successful is displayed in step S453. In the cancellation result page transmitted in step S452, the number of print jobs for which the printing stop has been successful and the number of print jobs for which the printing stop has been unsuccessful may be described.

When the cancel button has not been pressed before the processing in step S454 and the subsequent steps is started, processing in step S454 to step S485 is performed for each print job.

In step S454, the print processing unit 641 of the image forming device 600 corresponding to the device identification information included in the code image C transmits a request to acquire print data to the second print service system 200. In response to the request, in step S455, the print control unit 231 of the second print service system 200 transmits the converted print data to the image forming device 600.

After step S455, the processing in step S456 to step S466 is executed every time the job state changes. These kinds of processing are executed when the print processing has been started in the image forming device 600 or when an error has occurred after the print processing has been started.

In step S456, the print processing unit 641 of the image forming device 600 notifies the job state to the second print service system 200. When the second print service system 200 receives this notification, in step S457, the print control unit 231 of the second print service system 200 notifies the job state notified in step S456 to the relay server 300 together with the printer ID and the job ID2. Accordingly, the print control unit 335 of the relay server 300 acquires the job state of the print processing by the image forming device 600.

When the relay server 300 receives the notification of the job state, in step S458, the print control unit 335 of the relay server 300 performs reading processing for the database of the storage unit 310 or the like in order to acquire information stored in correlation with the received printer ID and the received job ID2. Accordingly, in step S459, the print control unit 335 reads the virtual printer ID and the job ID stored in correlation with the printer ID and the job ID2. In step S460, the print control unit 335 of the relay server 300 notifies the job state notified in step S457 to the first print service system 100 together with the virtual printer ID and the job ID. That is, when acquiring the job state from the second print service system 200, the print control unit 335 transmits the job state to the first print service system 100.

In step S461, the state output unit 564 of the second terminal device 500 transmits, to the first print service system 100, while designating the virtual printer ID and the job ID, a request to acquire the job information. In response to the request, in step S462, the print control unit 132 of the first print service system 100 transmits the job state received in step S460 to the second terminal device 500. Accordingly, in step S463, the state output unit 564 of the second terminal device 500 displays the job state on the display unit 520 of the second terminal device 500.

The display of the job state may be performed in the first terminal device 400. In this case, in step S464, the state output unit 453 of the first terminal device 400 transmits, to the first print service system 100, while designating the virtual printer ID and the job ID, a request to acquire the job information. On the other hand, in step S465, the print control unit 132 of the first print service system 100 transmits the job state received in step S460 to the first terminal device 400. Accordingly, in step S466, the state output unit 453 of the first terminal device 400 displays the job state on the display unit 420 of the first terminal device 400.

As it is seen from this sequence chart, every time the job state is updated, the print control unit 335 of the relay server 300 transmits the updated job state to the first print service system 100. Therefore, the user can appropriately grasp the current job state via the first print service system 100.

Subsequently, processing (step S467 to step S474) executed in the print system 10 when the cancel button is pressed after the processing in step S454 has been started is explained.

The user who desires to stop the printing presses the cancel button displayed on the printing reception page in step S467. In step S468, the Web browser 561 transmits a printing stop instruction to the relay server 300. That is, in the present embodiment, the instruction transmission unit 563 implemented as the Web browser 561 transmits the printing stop instruction. Accordingly, the relay server 300 receives the printing stop instruction.

When the relay server 300 receives the printing stop instruction, processing in step S469 to step S472 is performed for each print job. Here, for the stop target print job, when the job state notified to the relay server 300 from the second print service system 200 for the stop target print is a printing-in-progress state or a printing end state, the processing in step S469 is performed. In step S469, the print control unit 335 of the relay server 300 determines that the cancellation of the print processing has been unsuccessful for the print job. On the other hand, when the job state notified to the relay server 300 from the second print service system 200 for the stop target print job is a state before the printing start, the processing in step S470 and step S471 is performed. In step S470, the print control unit 335 of the relay server 300 designates a print job with the job ID2 and requests the second print service system 200 to cancel processing for the print job. In response to the request, when the image forming device 600 has not started printing for the print job, the print control unit 231 of the second print service system 200 cancels the print job in step S471. Then, the print control unit 231 transmits, to the relay server 300, a cancellation result indicating that the cancellation has been successful. However, in some case, it is also possible that the printing for the print job has already been started by the image forming device 600. For example, such a case can occur because of a time lag in notifying the latest job state to the relay server 300. In this case, in step S471, the print control unit 231 of the second print service system 200 fails in the cancellation of the print job and transmits a cancellation result indicating that the cancellation has been unsuccessful to the relay server 300. When receiving the cancellation result indicating that the cancel has been successful from the second print service system 200, in step S472, the print control unit 335 of the relay server 300 notifies the job state to the first print service system 100 together with the virtual printer ID of the virtual printer for code and the job ID of the cancellation target. Specifically, the print control unit 335 notifies, to the first print service system 100, a job state indicating a state in which the cancellation has been performed.

When the processing in step S469 and subsequent steps has been performed for all the cancellation target print jobs, the processing proceeds to step S473. In step S473, the print control unit 335 of the relay server 300 transmits a cancellation result page to the Web browser 561. In the cancellation result page, the number of print jobs for which the printing stop has been successful and the number of print jobs for which the printing stop has been unsuccessful. In step S474, the Web browser 561 displays the cancellation result page on the display unit 520 of the second terminal device 500.

When the cancel button is not pressed after the processing in step S454 has been started, processing in step S475 and subsequent steps is performed after the processing in step S456 to step S466 explained above.

In step S475, when the print processing for the print job ends, the print processing unit 641 of the image forming device 600 notifies the end of the printing to the second print service system 200 by notifying a processing result of the print job. Specifically, the print processing unit 641 notifies whether the print processing has been normally completed. That is, the print processing unit 641 notifies whether the printing has been successful or the printing has been unsuccessful. When the second print service system 200 receives this notification, in step S476, the print control unit 231 of the second print service system 200 notifies the processing result notified in step S475 to the relay server 300 as a job state together with the printer ID and the job ID2. Accordingly, the print control unit 335 of the relay server 300 acquires the job state of the print processing by the image forming device 600.

When the relay server 300 receives the notification of the job state, in step S477, the print control unit 335 of the relay server 300 performs reading processing for the database of the storage unit 310 or the like in order to acquire information stored in correlation with the received printer ID and the received job ID2. Accordingly, in step S478, the print control unit 335 reads the virtual printer ID and the job ID stored in correlation with the printer ID and the job ID 2.

Subsequently, in step S479, the print control unit 335 of the relay server 300 notifies the job state to the first print service system 100 together with the virtual printer ID and the job ID. That is, when acquiring the job state from the second print service system 200, the print control unit 335 transmits the job state to the first print service system 100.

In step S480, the state output unit 564 of the second terminal device 500 transmits, to the first print service system 100, while designating the virtual printer ID and the job ID, a request to acquire the job information. In response to the request, in step S481, the print control unit 132 of the first print service system 100 transmits the job state received in step S479 to the second terminal device 500. Accordingly, in step S482, the state output unit 564 of the second terminal device 500 displays the job state on the display unit 520 of the second terminal device 500.

The display of the job state may be performed in the first terminal device 400. In this case, in step S483, the state output unit 453 of the first terminal device 400 transmits, to the first print service system 100, while designating the virtual printer ID and the job ID, a request to acquire the job information. In response to the request, in step S484, the print control unit 132 of the first print service system 100 transmits the job state received in step S479 to the first terminal device 400. Accordingly, in step S485, the state output unit 453 of the first terminal device 400 displays the job state on the display unit 420 of the first terminal device 400.

The print system 10 according to the embodiment is explained above. With the print system 10, authentication printing using authentication by the first print service system 100 is implemented in the print system in which different systems that provide print services cooperate with one another. For this reason, unauthorized use of the system can be prevented. Even when the second print service system 200 does not include an authentication function, authentication printing can be implemented in printing in the image forming device 600 connected to the second print service system 200. Further, with the print system 10, even in the print system in which different systems that provide print services cooperate with one another, the user can designate the image forming device 600 to be used for printing using the code image C attached to the image forming device 600. For this reason, erroneous selection of the image forming device 600 to be used can be reduced compared with when the user selects the image forming device 600 to be used on the screen. Therefore, the convenience of the user is improved. Furthermore, with the print system 10, in the print system in which different systems that provide print services cooperate with one another, after the user designates the image forming device 600 to be used for printing, a detailed print setting corresponding to the designated image forming device 600 can be input or changed according to necessity. Therefore, since the user can use various functions of the image forming device 600 without limitation, it is possible to implement printing conforming to a desire of the user.

The present disclosure is not limited to the embodiment explained above and can be modified as appropriate without departing from the gist of the present disclosure. For example, the relay server 300 may be provided in the second print service system 200. With such a configuration, for example, the same vendor can easily manage the relay server 300 and the second print service system 200. In the embodiment explained above, the relay server 300 performs the processing for enabling designation of the image forming device 600 using the code image C in order to perform printing in the image forming device 600 connected to the second print service system 200. However, the relay server 300 may perform processing of enabling designation of an image forming device using the code image C in order to perform printing in the image forming device connected to the first print service system 100. In this case, the relay server 300 may perform the processing explained in the embodiment with the first print service system 100 as the processing performed with the second print service system 200.

In the example explained above, the program includes a command group (or software codes) for causing a computer to perform one or more functions explained in the embodiment when the program is read by the computer. The program may be stored in a non-transitory computer-readable medium or a tangible storage medium. Not as a limitation but as an example, the computer-readable medium or the tangible storage medium includes a random-access memory (RAM), a read-only memory (ROM), a flash memory, a solid-state drive (SSD), or other memory techniques, a CD-ROM, a digital versatile disk (DVD), a Blu-ray (registered trademark) disk, or other optical disc storages, and a magnetic cassette, a magnetic tape, and a magnetic disk storage, or other magnetic storage devices. The program may be transmitted on a transitory computer-readable medium or a communication medium. Not as a limitation but as an example, the transitory computer-readable medium or the communication medium includes an electrical propagation signal, an optical propagation signal, an acoustic propagation signal, or propagation signals of other forms.

What is claimed is:

1. A server connected to a first print service system that receives print data from a first user terminal and a second print service system that is connected to a plurality of image forming devices and instructs an image forming device selected by using a second user terminal among the plurality of image forming devices to print the print data, the server comprising:
a capability information controller configured to acquire, from the second print service system, capability information of the image forming device selected by using the second user terminal and transmit the capability information to the second user terminal; and
a print controller configured to receive, from the second user terminal, print setting information corresponding to the capability information and request the second print service system to perform printing of the print data corresponding to print setting information by the image forming device selected by using the second user terminal.

2. The server according to claim 1, wherein the print controller receives the print data from the first print service system, processes the print data based on the print setting information, and transmits the processed print data to the second print service system.

3. The server according to claim 1, wherein the print controller transmits, to the second print service system, an access destination for the second print service system to acquire the print data from the first print service system.

4. The server according to claim 2, wherein the print controller transmits the print setting information to the second print service system.

5. The server according to claim 1, wherein the capability information controller acquires, from the second print service system, initial print setting information corresponding to the capability information together with the capability information of the image forming device selected using the second user terminal and transmits the initial print setting information to the second user terminal together with the capability information.

6. The server according to claim 5, wherein the print setting information is information indicating that a print setting input or changed using the second user terminal is used or the initial print setting information is used without being changed.

7. The server according to claim 1, wherein
code images including identification information of the image forming devices corresponding thereto are respectively added to the plurality of image forming devices, and
the server identifies, based on the identification information received from the second user terminal that read the code image, the image forming device selected using the second user terminal.

8. The server according to claim 1, further comprising an authentication controller configured to acquire authentication completion information indicating that authentication by the first print service system is completed, wherein the print controller acquires a print job from the first print service system using the authentication completion information, and transmits a request for causing the image forming device to execute printing for the print job to the second print service system.

9. The server according to claim 1, wherein the server is provided in the second print service system.

10. A print system comprising:
a plurality of image forming devices; and
a server connected to a first print service system that receives print data from a first user terminal and a second print service system that is connected to the plurality of image forming devices and instructs an image forming device selected by using a second user terminal among the plurality of image forming devices to print the print data,
the server including:
a capability information controller configured to acquire, from the second print service system, capability information of the image forming device selected by using the second user terminal and transmit the capability information to the second user terminal; and
a print controller configured to receive, from the second user terminal, print setting information corresponding to the capability information and request the second print service system to perform printing of the print data corresponding to print setting information by the image forming device selected by using the second user terminal.

11. An information processing method comprising a server connected to a first print service system that receives print data from a first user terminal and a second print service system that is connected to a plurality of image forming devices and instructs an image forming device selected by using a second user terminal among the plurality of image forming devices to print the print data:
acquiring, from the second print service system, capability information of the image forming device selected by using the second user terminal and transmitting the capability information to the second user terminal; and
receiving, from the second user terminal, print setting information corresponding to the capability information and requesting the second print service system to perform printing of the print data corresponding to the print setting information by the image forming device selected by using the second user terminal.

12. A non-transitory computer-readable storage medium storing a program, the program causing a server connected to a first print service system that receives print data from a first user terminal and a second print service system that is connected to a plurality of image forming devices and instructs an image forming device selected by using a second user terminal among the plurality of image forming devices to print the print data to function as:
a capability information controller configured to acquire, from the second print service system, capability information of the image forming device selected by using the second user terminal and transmit the capability information to the second user terminal; and
a print controller configured to receive, from the second user terminal, print setting information corresponding to the capability information and request the second print service system to perform printing of the print data corresponding to print setting information by the image forming device selected by using the second user terminal.
